(19) United States
(12) Patent Application Publication
(10) Pub. No.: US 2018/0039961 A1
(43) Pub. Date: Feb. 8, 2018

(54) SYSTEM AND METHOD FOR ELECTRONIC PROCESSING OF AGRICULTURAL PRODUCTS

(71) Applicant: AGRICLEAR LIMITED PARTNERSHIP BY ITS GENERAL PARTNER AGRICLEAR INC., Calgary (CA)

(72) Inventors: Catherine BLOUIN, Calgary (CA); Doug BROWN, Calgary (CA); Charles Vernon JOHNSTONE, Calgary (CA); Kevin KLASSEN, Calgary (CA); Ricky Yat Chiu LAI, Calgary (CA); Peter Kelly LAPRAIRIE, Calgary (CA); Colin Gregory PAYNE, Calgary (CA); Ursula Elaine ROBERTSON, Calgary (CA); Madhav SHRESTHA, Calgary (CA); Andrew TAYLOR, Calgary (CA)

(21) Appl. No.: 15/554,265

(22) PCT Filed: Mar. 4, 2016
(86) PCT No.: PCT/IB2016/051250

§ 371 Date: Aug. 29, 2017

Related U.S. Application Data
(60) Provisional application No. 62/175,820, filed on Jun. 15, 2015.
(60) Provisional application No. 62/128,863, filed on Mar. 5, 2015.

(51) Int. Cl. G06Q 20/12; G06Q 20/02

(52) U.S. Cl. CPC G06Q 20/12; G06Q 20/02

(57) ABSTRACT

A listings system is coupled to a payment-settlement system and serves terminals operated by buyers and sellers of an agricultural product, such as cattle, as well as other users. The listings system and payment-settlement system communicate via network-based message passing. The listings system allows entering, viewing, and acceptance of objects representing listings for purchase or sale (offer) of the product and counteroffers. The listings system further provides for structured negotiations based on predefined attributes of the agricultural product, including structured negotiations for pre and post-delivery adjustments.

### CROSS-REFERENCE TO RELATED APPLICATIONS

This application claims priority to U.S. provisional patent application Ser. No. 62/128,863, filed Mar. 5, 2015, and U.S. provisional patent application Ser. No. 62/175,820, filed Jun. 15, 2015, the entireties of which are incorporated herein by reference.

### FIELD

This disclosure relates to electronic data processing.

### BACKGROUND

Past attempts to provide electronic systems for the exchange and delivery of agricultural products have suffered from structural and technical problems. For example, attempts have been made to provide systems that match buyers and sellers and execute transactions for the purchase and sale of cattle. However, such attempts have failed to address the need to process a high volume of transactions with the level of trust expected by the parties involved. In some examples, transactions are closed upon delivery of the product, with little provision made for an orderly handling of adjustments based on the actual product delivered. In other examples, payments are delayed or processed erroneously due to communications inefficiencies in dealing with systems of third-party financial institutions, which may require that communications regarding account data be subject to schemas and rules outside the control of the electronic systems for the exchange and delivery of agricultural products.

Other technical features that make viable the electronically facilitated exchange and delivery of agricultural products are also missing from the state-of-the-art.

### SUMMARY

Systems and processes discussed herein relate to the tight integration of a listings system and separate payment-settlement system. The listings system and payment-settlement system are distinct and separate electronic systems that communicate through the exchange of electronic messages. This can permit the listings and payment-settlement system to be operated by distinct entities according to their own internal processes, so as to facilitate the handling of a large volume of transactions and provide a level of security and trust to buying and selling parties that are not found in the art.

Systems and processes discussed herein provide for post-delivery adjustments of electronic contracts for the purchase and sale of agricultural products. Such adjustments can be determined from a structured negotiation process, which may include automatic calculations. Agreed or arbitrated adjustments are sent to a payment-settlement system for payment handling.

### BRIEF DESCRIPTION OF THE DRAWINGS

The drawings illustrate, by way of example only, embodiments of the present disclosure.

FIG. 1 is a diagram of a system for processing the exchange of an agricultural product.

FIG. 2 is block diagram of a listings server.

FIG. 3 is a diagram of an example structure for a listings object.

FIG. 4 is a schematic diagram of a structured negotiation for the exchange of an agricultural product.

FIG. 5 is diagram of example listings, offer, and associated counteroffer objects.

FIG. 6 is flowchart of a structured negotiation process for the exchange of an agricultural product.

FIG. 7 is a diagram of an example structure for a payment-settlement object.

FIG. 8 is a schematic diagram of payment processing.

FIG. 9 is a schematic diagram of a structured negotiation of adjustments.

FIG. 10 is a schematic diagram of adjustment payment processing.

FIG. 11 is a diagram of an example structure for an adjustment object.

FIG. 12 is a flowchart of a structured negotiation of adjustments.

FIGS. 13A-13M show various user interfaces of the listings engine.

FIG. 14 is a diagram of components of the financial service system and the payment settlement system.

FIG. 15 is a diagram of an example structure for an incoming payment message and a payment message record definition.

FIG. 16 is a flowchart of a continuation data parsing process.

FIG. 17 is a diagram of a process for transforming incoming payment messages into matched payment records.

FIG. 18 is a flowchart of a pre-filtering process.

FIG. 19 is a flowchart of a matching process.

FIG. 20 is a flowchart of another matching process.

FIG. 21 is a flowchart of a process for determining levies.

FIG. 22 is a flowchart of a process for determining exemptions for levies.

FIG. 23 is a diagram of example levy data.

### DETAILED DESCRIPTION

The systems and processes described herein are contemplated for use in the electronic trading of agricultural products, such as cattle, forages, and similar. Buyer and seller parties participate in an electronic trade, and subsequently, the agricultural product is delivered to the buyer and payment is settled.

Cattle, in particular, is a suitable agricultural product for use with the systems and processes described herein. Parties involved in electronic trade of cattle, who may find use in the present invention, are contemplated to be ranchers, cow/calf operators, backgrounders, stocker/grassers, finishing feedyards, stockyards, live export facilities, abattoirs, packers, and similar.

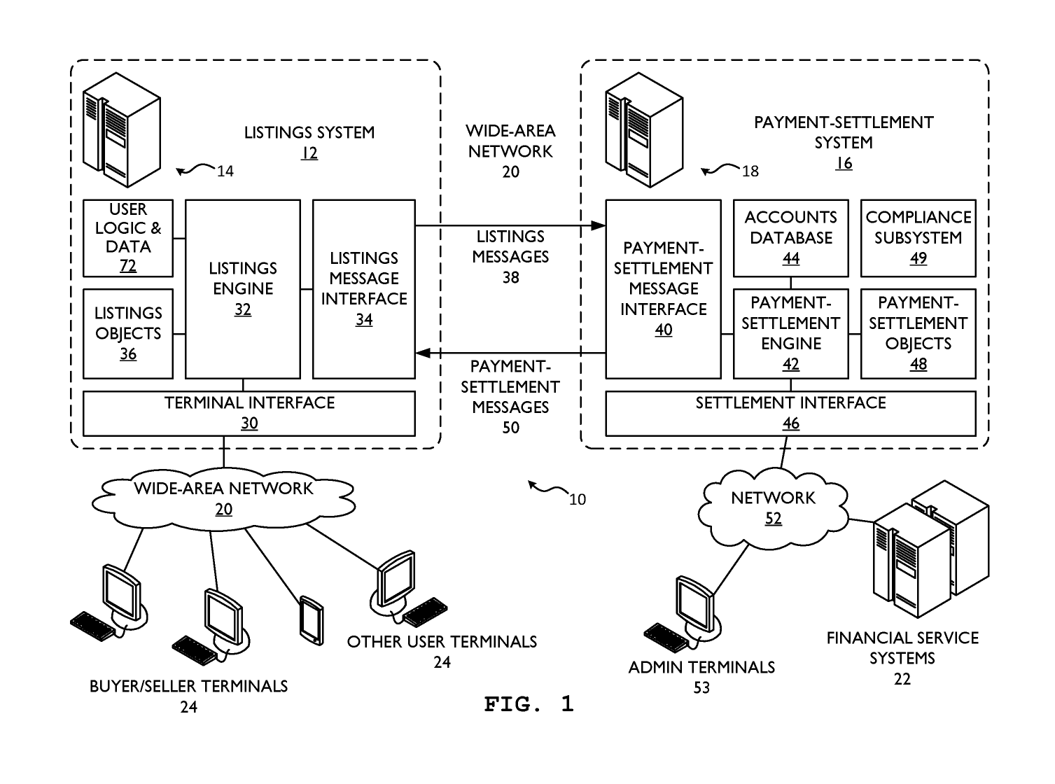

FIG. 1 shows a system 10 for processing the exchange of one or more agricultural products, such as cattle, forages, and similar. The system 10 includes a listings system 12 having at least one listings server 14 and a payment-settlement system 16 having at least one payment-settlement server 18. The payment-settlement server 18 is separate from the listings server 14. The payment-settlement server 18 and the listings server 14 can be located within distinct domains and operated by distinct entities, and can communicate through a wide-area network 20. The payment-settlement server 18 and one or more financial service systems 22 exchange data. A plurality of buyer remote terminals and a plurality of seller remote terminals, collectively indicated as terminals 24, connect to the listings system 12 via the wide-area network 20. Buyers and sellers at the terminals 24 conduct exchanges of the agricultural product through the listings system 12, which communicates with the payment-settlement system 16 to settle payment for such exchanges of the agricultural product.

The system 10 can support the contemporaneous trading of multiple different agricultural products. However, for sake of explanation, a single agricultural product, cattle, will be discussed as an example.

The wide-area network 20 includes local networks forming part of the systems 12, 16 as well as a wider system, such as the Internet. The wide-area network 20, and particularly the coupling to the terminals 24, may include a wireless local-area network, a cellular network, or similar to permit the terminals 24 to be portable and to function across multiple end-user devices, such as desktop computers, laptop computers, tablet computers, mobile smart-phones, and others. The wide-area network 20 supports protocols to facilitate secure communications between the systems 12, 16, such as Hypertext Transfer Protocol Secure (HTTPS) and Secure Socket Layer (SSL), for example.

The listings server 14 includes a terminal interface 30, a listings engine 32, and a listings message interface 34. The listings engine 32 is configured to control the creation and updating of listings objects 36 representative of contracts for purchase and sale of the agricultural product.

The terminal interface 30 is configured to receive input data from the terminals 24 for entering, viewing, and selecting listings objects 36. The terminal interface 30 includes a web server that generates webpages based on listings objects 36, outputs such webpages to the terminals 24, and accepts input from such webpages to enter, view, and select the underlying listings objects 36. The terminal interface 30 need not be limited to a web server generating webpages and can, alternatively or additionally, be configured to support the viewing and manipulation of listings objects 36 via a dedicated application or similar program executing at the terminals 24.

The listings engine 32 is configured to process state for each listings object 36. Each listings object includes values for a plurality of predefined attributes of the agricultural product. The listings objects 36 can be updated based on input from the terminals 24. The state of each listings object 36 is configured to range from the creation of the listing (In Preparation), Live, In Negotiation, Sold, Buyer Payment, Shipped, Delivered, Post Delivery Negotiations, to Complete.

The listings message interface 34 is configured to output listings messages 38 via the network 20 to the payment-settlement system 16. The listings messages 38 are indicative of the states of the listings objects 36, as controlled by the terminals 24. The listings messages 38 are used by the payment-settlement system 16 to track the state of the contract for delivery of the agricultural product, at least as far as needed for payment processing. The listings message interface 34 can include a Representational State Transfer (REST)-ful application program interface (API) exposed to a like interface of the payment-settlement system 16. Listings messages 38 can include API calls to an API of the payment-settlement system 16. The listings message interface 34 is configured to support message queuing for guaranteed delivery.

The listings server 14 further includes user accounts logic and data 72 configured to handle user log-in, authentication, and security. User accounts store personal information (e.g., name, telephone number, address, etc.), business details (e.g., name, address, etc.), associations between business and individuals (e.g., roles of individuals at businesses), as well as preferences, settings, and permissions. User accounts logic and data 72 is configured to store company legal entity name, which may include operating company name, holding company name, company number (for numbered companies), and similar. User accounts logic and data 72 is also configured to store operational names for companies, such as “operating as”, “doing business as”, “DBA”, and similar. The listings engine 32 communicates to parties at the terminals 24 with reference to the user accounts logic and data 72 to provide the correct data context to the parties. The user accounts logic and data can also be configured to handle updates of financial account data stored at the accounts database 44 of the payment-settlement system 16. The user accounts logic and data triggers output of suitable listings messages 38 at the listings message interface 34 to achieve this.

The payment-settlement server 18 includes a payment-settlement message interface 40, a payment-settlement engine 42, an accounts database 44, and a settlement interface 46. The payment-settlement engine 42 is configured to control the creation and update of payment-settlement objects 48 containing payment and settlement transaction details of the contracts. Each payment-settlement object 48 corresponds to a different listings object 36 and contains at least a subset of data contained in the listings object 36, the subset of data storing transaction details, such as identifiers for buyer and seller parties, for the contract represented by the respective listings object 36. The payment-settlement object 48 itself can be considered to represent a pending or executed transaction.

The payment-settlement system 16 may further include an agricultural regulatory compliance subsystem 49 that facilitates users' compliance with agricultural regulation such as, for example, prompt payment requirements in a Cattle market. The payment-settlement system 16 is configured to track and manage such payment deadlines imposed by legislation. Alternatively or additionally, all of or a subset of the rules implemented at the agricultural regulatory compliance subsystem 49 may be provided at the listings system 12 in a similar subsystem. It is advantageous that at least one of the listings system 12 and the payment-settlement system 16 is structured for agricultural regulatory compliance, as this may provide a level of trust expected by buying and selling parties at the terminals 24.

The payment-settlement message interface 40 is connected to the listings message interface 34 via the wide-area network 20 and is configured to receive listings messages 38 from the listings message interface 34. The payment-settlement message interface 40 is further configured to send payment-settlement messages 50 to the listings message interface 34. The payment-settlement message interface 40 can include a RESTful API that is exposed to the listings message interface 34. Payment-settlement messages 50 can include API calls to the listings message interface 34. The payment-settlement message interface 40 is configured to support message queuing for guaranteed delivery.

The listings and payment-settlement messages 38, 50 are machine-readable messages and are not intended to be human-intelligible. The messages 38, 50 are JSON messages configured for RESTful web calls, or similar. The connection between the message interfaces 34, 40 includes an encrypted SSL connection and a VPN tunnel.

The accounts database 44 is configured to store account data associated with buyers and sellers at the terminals 24. Payment information can include an indication of a credit note from at least one of the financial service systems 22, and thus ensures payment is made to the appropriate credit provider relating to the agricultural asset being sold. Payment information can also include confirmation of advanced payment within a specified time prior to delivery (e.g., 2 days), or similar. Payment information can also be used for issuing partial or full refunds. Terminals 24 can update account data via the listings system 12 and listings messages 38.

The payment-settlement engine 42 is configured to receive listings messages 38 from the payment-settlement message interface 40 and to create payment-settlement objects 48 and process state of the payment-settlement objects 48 based on the listings messages 38. The payment-settlement engine 42 is further configured to output state of payment-settlement objects 48 to the payment-settlement message interface 40 for creation of payment-settlement messages 50 destined for the listings system 12. The payment-settlement engine 42 is further configured to execute transactions using payment-settlement objects 48 by outputting payment messages via the settlement interface 46, where such payment messages are ultimately delivered to the financial service systems 22. Each payment-settlement object 48 forms the basis for an executed transaction and corresponds to a listings object 36 that retains state defining the binding electronic contract underlying the transaction. A plurality of payment-settlement objects 48 can be associated to a single listings object 36 for multiple transactions on the same contract, such as an initial payment and one or more adjustments.

The settlement interface 46 indirectly or directly connects the payment-settlement engine 42 to financial service systems 22 via a network 52. In one example, an administrator terminal 53 facilitates indirect communication of data between the settlement interface 46 and the financial service systems 22. This may include downloading data from each of the payment-settlement engine 42 and a financial service system 22, and uploading such data to the other of the payment-settlement engine 42 and the financial service system 22. In another example, the settlement interface 46 directly communicates with the financial service systems 22 using one or more APIs or other interface. For executed transactions, the payment-settlement engine 42 can output settlement instructions to the related financial service system or systems 22 to effect payment, thereby settling transactions. The network 52 may be substantially the same as the network 20 or may be a private network operated by a financial service entity that implements the payment-settlement system 16. The settlement interface 46 can be configured to allow administrator terminals 53 to access the payment-settlement system 16 bypassing the listings system 12, and such access can be configured to allow administrators to obtain payment-settlement data, perform calculations and analytics on such data, and the like.

The listings objects 36 can be stored in a database, data store, file system, or other data storage system. The term “object” is used for explanatory purposes and is not intended to limit the listings objects 36 to an object-oriented language or environment, though such are indeed suitable to implement the listings objects 36. The same applies to the payment-settlement objects 48.

Each listings object 36 represents a contract for purchase or sale of the agricultural product. Each payment-settlement object 48 represents a completed or pending transaction for one of such contracts. The payment-settlement objects 48 are synchronized with the listings objects 36 via network-based passing of listings messages 38 and payment-settlement messages 50. The payment-settlement objects 48 and listings objects 36 are otherwise decoupled from each other. This architecture is advantageous, as the systems 12, 16 may be operated by different entities, and the payment-settlement system 16 may be subject to agricultural regulations that govern payment deadlines between buyer and seller. In the same vein, the listings system 12 can be configured to provide rich functionality (e.g., user-friendly searching, matching, counter-offering, and other functionality discussed herein) to buyer and seller parties, where such functionality may not be possible, desirable, feasible, or compatible with the payment-settlement system 16. Further, buyer and seller parties may find greater confidence in the total system 10 given that the agricultural regulatory-compliant payment-settlement system 16 settles the transactions, particularly when the payment-settlement system 16 is operated by a trusted third-party entity. Hence, the tightly integrated systems 12, 16 with message passing, as discussed herein, offer distinct advantages over known systems.

The listings object 36 is generic in the sense that it can represent initial listings for purchase and sale, counteroffers, and finalized binding contracts. The listings object 36 is further generic in that it applies to any agricultural product. Other examples of listings objects within the scope of the present invention will be apparent to those of ordinary skill in the art having the benefit of this disclosure. The listings object 36 may be stored in a database, such as a NoSQL database that stores objects as documents. Alternatively, a relational database may be used, in which objects are stored in rows and tables. The structure of the listings object 36 is not particularly limited.

It is contemplated that any agricultural product capable of being handled by the system 10 has the following predefined attributes, but these attributes are not intended to be limiting in any way. The predefined attributes are a shipping date on which the agricultural product is to be shipped from seller to buyer, one or more numerical quantities (e.g., head, bushels, gallons, tons, individual weight and total number, etc.), a geographic location of the product (e.g., its present location or origin), a unit price, a free-on-board (FOB) indicator, an indication of which party is to arrange transportation, text for product specifications, text for seller responsibilities, and text for buyer responsibilities. Text elements may include references to other data structures, files, or database elements that store such information. Further, text elements can include language that defines the legal context of the contract, such as standard contractual clauses concerning the agricultural product, agreement to binding dispute resolution, governing legal jurisdiction, and similar. The listings object 36 stores values of the predefined attributes, as received from or selected by the terminals 24. Some values may be set to be immutable, such as attributes that define the legal context of the contract.

Adjustment objects are created to define delivered attributes of the agricultural product after or during delivery. Adjustment objects have similar or the same structure as listings objects 36, or are otherwise compatible with listings objects 36. Delivered attributes represent the differences in the product as actually delivered versus what was listed. Delivered attributes may be quantitative or qualitative and therefore possibly subjective. One or more adjustment objects may be created by the buyer or seller for the same or different predefined attributes, such that the process may be considered a structured negotiation for one or more adjustments.

The listings engine 32 is configured to receive or calculate an adjustment value for one or more adjustment objects. Received adjustment values are received from terminals 24 operated by the parties to the sale as proposed monetary values while the adjustment is negotiated. Arbitrated and calculated adjustment values can be applied to assist in the structured negotiation of adjustments. At any point in the adjustment process, a listings message 38 reflecting an adjustment object can be sent to the payment-settlement system 16 for generation of an associated payment-settlement object 48.

The listings server 14 and the payment-settlement server 18 each operates on a processor and connected memory. The processor is configured to execute instructions, which may originate from the memory or a network. The processor may be known as a CPU. The processor can include one or more sub-processors or processing cores. The memory includes a non-transitory machine-readable medium that is configured to store programs and data. The memory can include one or more short-term or long-term storage devices, such as a solid-state memory chip (e.g., DRAM, ROM, non-volatile flash memory), a hard drive, an optical storage disc, and similar. The memory can include one or both of fixed components that are not physically removable (e.g., fixed hard drives) and removable components (e.g., removable memory cards). The memory allows for random access, in that programs and data may be both read and written. The processor and memory operate in conjunction to execute the engines, databases, and similar components discussed herein. Although one listings server 14 and one payment-settlement server 18 are shown, it is contemplated that multiple of such servers can be used to implement the functionality described. Various functional components can be provided to various servers, and servers need not be co-located.

The terminals 24 each include a processor, memory, a network interface, and a display and other user-interface components. The processor, memory, network interface, and display and user interface are electrically interconnected and can be physically contained within a housing or frame. A terminal 24 may be a desktop computer, smartphone, tablet computer, or the like. The terminals 24 need not be limited to use by buyer and seller parties, and it is advantageous that other users, such as certification authorities, arbitrators, and system administrators can use terminals 24 to access the system 10. The processor of each of the terminals 24 is configured to execute instructions, which may originate from the memory or the network interface. The processor may be known as a central processing unit (CPU). The processor can include one or more sub-processors or processing cores. The memory of each of the terminals 24 includes a non-transitory computer-readable medium that is configured to store programs and data. The memory can include one or more short-term or long-term storage devices, such as a solid-state memory chip (e.g., DRAM, ROM, non-volatile flash memory), a hard drive, an optical storage disc, and similar. The memory can include fixed components that are not physically removable from the terminal (e.g., fixed hard drives) as well as removable components (e.g., removable memory cards). The memory allows for random access, in that programs and data may be both read and written. The network interface of each of the terminals 24 is configured to allow the terminal to communicate with servers and terminals across one or more networks. The network interface can include one or more of a wired and wireless network adaptor and well as a software or firmware driver for controlling such adaptor. The display and other user interface components can include a display device, such as a monitor and an input device, such as a keyboard, keypad, mouse, touch-sensitive element of a touch-screen display, or similar device. Each of the terminals 24 is configured to run a user agent, such as a web browser, application, or other suitable program to communicate with the terminal interface 30 of the listings system 12.

In operation, a first terminal 24 provides data representing a listings object 36 to the listings system 12. The data includes values for a plurality of predefined attributes of the agricultural product. When the party at the first terminal 24 wishes to sell the agricultural product, the listings object 36 represents an offer to sell. Conversely, when the party at the first terminal 24 wishes to buy, the listings object 36 represents an offer to buy the agricultural product. A party at a second remote terminal 24 indicates values of the predefined attributes that would be acceptable (i.e., a counter-offer) or indicates that the current values of listings object are acceptable (i.e., a binding contract is formed). If a party at a second remote terminal 24 provides a counter-offer, a negotiation with enforced structure takes place. A binding electronic contract between parties is finalized upon acceptance by both parties of the attribute values, and an initial payment-settlement object 48 is created to handle payment for the product. The agricultural product is delivered to the buyer party as per the relevant attribute values of the contract. The buyer evaluates the delivered product and can use the terminal 24 to enter one or more delivered attributes of the agricultural product that maps to a predefined attribute of the listings object 36. A delivered attribute may represent an aspect of quality of the product (e.g., condition) or an aspect of quantity (e.g., number of head). The delivered attribute is stored with the listings object and triggers creation of another payment-settlement object 48 for an adjustment to the contract based on the quality or quantity. Several delivered attributes can be received from either the buyer or seller terminal 24 or both terminals 24 by way of a structured negotiation of adjustments. The payment-settlement system 16 processes the payment-settlement objects 48 to settle the purchase of the agricultural product based on the adjusted binding electronic contract. The payment-settlement object 48 concerning the initial, pre-delivery payment is processed as a condition for delivery to be commenced. Payment for the payment-settlement objects 48 concerning adjustments are processed after delivery when subjective and objective attributes of the product can be properly ascertained. When multiple payment-settlement objects 48 concerning adjustments exist for a particular delivery, such objects can be processed asynchronously. Actual payment to the seller can be held until all adjustments are processed, so that one deposit is made to the seller.

The structured negotiations before the contract is finalized and for adjustments after delivery of the product offer advantages over known techniques, in that the system 10 allows for flexible end-to-end delivery of a product that may have variable or uncertain attributes and attributes that are affected by time and by the nature of the transaction itself. Further, each element of the structured negotiations is stored in the system 10 for future reference in case of formal legal dispute.

One output of the negotiation process, when successful, is a listings message 38 that is sent to the payment-settlement system 16. The payment-settlement system 16 is configured to create a payment-settlement object 48 in response to receiving such message and to process payment for the exchange of the agricultural product using the payment-settlement object 48.

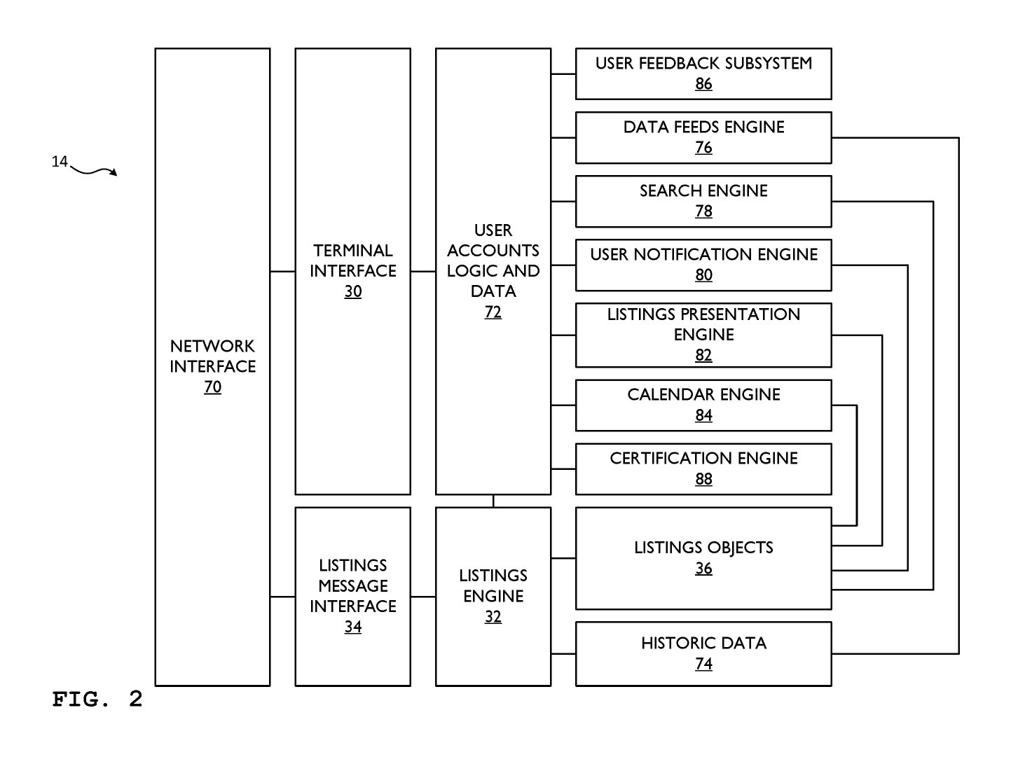

FIG. 2 shows an example of the listings server 14. The listings server 14 operates on a processor and connected memory.

The listings server 14 further includes a network interface 70 that is configured to allow the listings server 14 to communicate with other servers or terminals across one or more networks. The network interface 70 can include one or more of a wired and wireless network adaptor and well as drivers for controlling such adaptors.

The terminal interface 30 is connected to the network interface and includes a web front-end, server-side application interface, or similar component configured to provide at least an interface for data communications with the terminals 24 connected to the listings server 14. The web front-end supports data entry for listings objects 36 via web forms or similar and further supports output of active listings. Various other components of the listings server 14 are accessible to the terminals 24 through the web front-end.

The terminal interface 30 can enforce validation conditions on listings objects 36. Validation conditions include any combination of indications of mandatory form fields, types of data permitted in form fields, permissible ranges of numbers or expressions of text, and similar. The terminal interface 30 provides immediate feedback to the terminals 24 to prompt immediate correction of inputted information. Feedback can include, for example, messages displayed on the form at a terminal 24. The validation conditions prevent the creation of erroneous listings objects. The validation conditions express the fundamental and immutable policies of the system 10 and also serve to catch trivial errors in data entry.

The listings server 14 further includes user accounts logic and data 72 configured to handle user log-in, authentication, and security; store and maintain user data; and handle updates of financial account data stored at the accounts database 44 of the payment-settlement system 16, as discussed above.

A user feedback subsystem 86 can be coupled to the user accounts logic and data 72, so that parties at the terminals 24 can provide feedback associated with listings objects 36 indicative of the behaviour of the buyer/seller parties controlling the listings objects 36.

The listings server 14 further stores historic data 74, which includes data of listings objects 36 representing contracts that were completed, cancelled, or otherwise closed. The listings engine 32 can be configured to store the data of a listings object 36 to the historic data 74 before the listings object 36 is closed and ultimately deleted. Not all data of listings object 36 need be added to the historic data 74. However, storing objects for all stages of a negotiation can advantageously maintain the history of an individual transaction.

The listings server 14 can further include other components, such as a data feeds engine 76, search engine 78, user notification engine 80, listings presentation engine 82, calendar engine 84, certification engine 88, and document handling subsystem.

The data feeds engine 76 is configured to process historic data 74 into one or more reports or data feeds. Reports can be outputted to parties at terminals 24 via the terminal interface 30 as controlled by the user accounts logic and data 72. Data feeds can be outputted via the terminal interface 30 and may be made more widely available than permitted by the user accounts logic and data 72, such as being provided as public data feeds available to any party with a computer. Examples of reports and data feeds include unit price over time, number of buy listings vs. number of sell listings, sales volume or value by type of agricultural product, market share by varieties of agricultural product, and similar. The data feeds engine 76 may also be coupled to the network interface 70 to obtain data from outside the system 10, so that such outside data can be blended with historic data 74 internal to the system for the purpose of generating reports and data feeds.

The search engine 78 is configured to provide for execution of search queries by terminals 24 based on the values of the attributes of the listings objects 36. Search queries may be saved at the listings server 14 in association with user accounts data for subsequent execution. Search results can be structured to organize listings objects 36 meeting the query in any manner desired, and may be saved by the user for future reference, and to aid in establishing a price point when listing agricultural products for sale or purchase.

The user notification engine 80 is configured to present notifications to the terminals 24 as controlled by the user accounts logic and data 72, so that parties can be informed of new listings (initial offers), counteroffers, requests for adjustment, changes to a watch list, upcoming calendar events, and similar events. The user notification engine 80 is configured to monitor for changes to the listings objects 36 based on user preferences and settings. Notifications can be sent by any suitable pathway including as messages stored within the system 10, email messages, short message service (SMS) messages, and similar.

The listing presentation engine 82 is configured to present specific listings objects 36 to terminals 24 as controlled by the user accounts logic and data 72. Example presentations include offer lists, counteroffer lists, watch lists, and distribution lists. Offer lists are configured to present offers represented by listings objects 36 of interest to a party at a terminal 24. This allows the party at the terminal 24 to quickly evaluate offers and select an offer that is most suitable. Counteroffer lists are configured to list the party's listings object 36 that have counteroffers, which may include listing pertinent summary details about the counteroffers. Watch lists are configured to monitor listings objects 36 and send a notification to the party controlling the watch list when a watched-for change occurs in the listings objects 36. Distribution lists are configurable lists of subscribing parties that are to be sent notifications concerning new listings objects 36 that meet configurable criteria. Distribution lists that are controlled by sellers are contemplated to be subscribed by buyers, and vice versa.

The calendar engine 84 tracks dates associated with listings objects 36 and presents relevant data to the terminals 24 as controlled by the user accounts logic and data 72. Examples of tracked dates include shipping dates and payment due dates.

The certification engine 88 is configured to associate, dissociate, and store third-party certifications for the listings objects 36. Certification authorities can be provided with accounts at the user accounts logic and data 72, where such accounts are limited to controlling associations of certifications with listings objects 36. A terminal 24 operated by a certification authority can then be used to approve certifications claimed in particular listings objects 36. Examples of such certifications include Source Verified, Verified Beef Production, feeding programs, vaccination programs, supplement programs, growth programs, parasiticide programs, and similar. Certifications need not be legally established certifications. However, it is contemplated that certifications are made by third-party certification authorities. The listings engine 32 can be configured to display third-party certification objects (e.g., as text and/or images) for listings objects 36 when outputting such listings objects 36 to terminals 24. Certification objects are made available by the certification providers to be used in verified listings, so as to assist in enhancing the marketability of the listed agricultural product.

A document handling subsystem (not shown) includes logic and storage for handling documents, videos, and photos associated with listings objects 36. Various file types can be uploaded by a party that controls the listing and can be viewed by interested parties at the terminals 24.

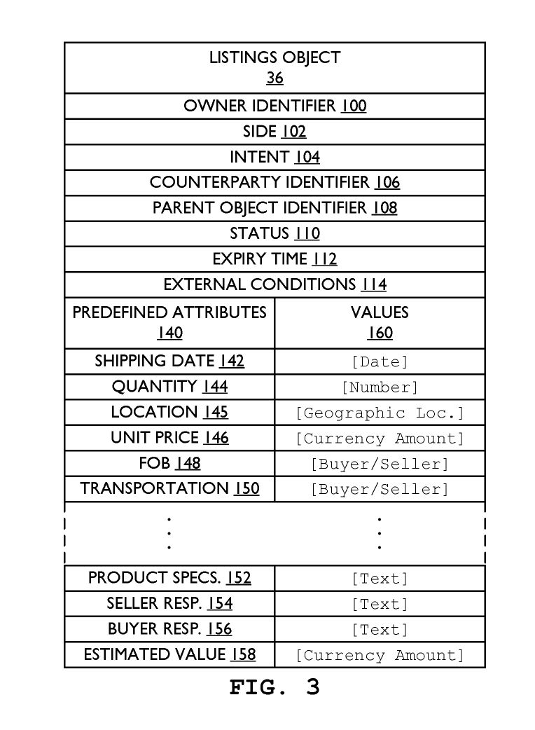

FIG. 3 shows an example listings object 36. The listings object 36 can represent initial listings for purchase and sale, counteroffers, and finalized binding contracts for any agricultural product.

The listings object 36 stores an owner identifier 100 that uniquely associates the listings object 36 with a party identified by the user accounts logic and data 72 of the listings system 12. The owner identifier 100 designates control of the listings object 36 and is referenced for permissions to view, modify, or delete the listings object 36 and for handling payments made against the listings object 36. The owner identifier 100 may point to a group of individual parties in implementations that permit pooling.

The listings object 36 stores a side identifier 102 that indicates whether the object 36 represents an offer to purchase or an offer to sell the agricultural product.

The listings object 36 can further store an intent identifier 104 that indicates the nature of the listings object 36, that is, whether the listings object 36 represents an initial listing (offer), a counteroffer on an existing listing, a counteroffer on a counteroffer, or a finalized contract. As an alternative to an intent identifier 104, various different data structures can be used to store initial listings, counteroffers, and finalized contracts. However, such data structures are contemplated to be similar or identical to the listings object 36 structure discussed herein, and therefore the intent identifier 104 is used for clarity of explanation and to avoid repetition.

The listings object 36 stores a counterparty identifier 106 that uniquely associates the listings object 36 with a party identified by the user accounts logic and data 72 of the listings system 12. The counterparty identifier 106 links the listings object 36 to a party on the other side of the contract. The counterparty identifier 106 is referenced for handling payments made against the listings object 36. The counterparty identifier 106 may point to a group of individual parties in implementations that permit pooling of products such as to allow for load-lot sizes to optimize transportation costs of agricultural products.

The listings object 36 stores a parent object identifier 108 that points to an associated listings object 36. A group of listings objects 36 may represent an initial listing, a counteroffer on such listing, and so on, and the parent object identifier 108 of each of such listings objects 36 can be used to define the group. A most-recent listings object 36 of a group may be determined as the listings object 36 that is not considered a parent by another listings object 36 in the group. Alternatively or additionally, a timestamp attribute may be provided for this purpose. Other techniques for associating listings objects 36 and determining the most recent thereof can alternatively be used.

The listings object 36 stores a status identifier 110 to track its current status. Statuses can include “In Preparation”, “Live”, “In Negotiation”, “Sold”, “On Hold”, “Withdrawn”, “Buyer Payment”, “Shipped”, “Delivered”, “Post Delivery Negotiations”, “Complete”, and similar. A status of “In Preparation” is set during listing creation when the listing (initial offer) is not yet completed and not available for view or to receive acceptance or counteroffers. A status of “Live” is set when the listing is available for acceptance or counteroffers but no particular counteroffer has yet been accepted or countered. A status of “In Negotiation” is set when the listing has one or more counteroffers, with the same counterparty, that have not yet been accepted or countered. Transition from the “Live” state to the “In Negotiation” locks the listing from acceptance or counteroffers by other parties. A status of “Sold” is set after the contract has been agreed and while payment is being processed and delivery is underway. A status of “On Hold” is set when the listing is on hold, and may be used when there is a problem with payment or delivery. A status of “Withdrawn” is set when the listing has been withdrawn by the party who owns the listing. A status of “Complete” is set when the transaction(s) for the listing, including adjustments, and the delivery of the product have been completed. A status of “In Dispute” is set when the counterparty rejects delivery of the agricultural product or otherwise wishes to dispute the contract. Other statuses or modifications of the above statuses within the scope of the present invention will be apparent to those of ordinary skill in the art having the benefit of this disclosure.

The listings object 36 further stores an expiry time 112, in the form of a date or a date and time. The listings system 12 is configured to set the status 110 of initial listings and counteroffers to “Withdrawn” when the expiry time is reached. This allows parties to make time-limited commitments. The expiry time 112 can be configured to be extendable by the party that owns the object.

The listings object 36 further stores external conditions 114, such as a buyer inspection condition. The listings system 12 is configured to set the status 110 of initial listings and counteroffers according to a triggered external condition 114.

The listings object 36 stores predefined attributes of the agricultural product. All or substantially all of the attributes handled by the system 10 are predefined in that entry of data is restricted to the attributes provided and the type of data accepted by each attribute. The listings object 36 is therefore formed of highly or exclusively structured data.

The following predefined attributes apply to any agricultural product: a shipping date 142 on which the agricultural product is to be shipped from seller to buyer, one or more numerical quantities 144 (e.g., head, bushels, gallons, tons, individual weight and total number, etc.), a geographic location 145 of the product (e.g., its present location or origin), a unit price 146, an FOB indicator 148, an indication of which party is to arrange transportation 150, text for product specifications 152, text for seller responsibilities 154, and text for buyer responsibilities 156. The text elements 152-156 may include references to other data structures, files, or database elements that store such information. Further, the text elements 152-156 can include language that defines the legal context of the contract, such as standard contractual clauses concerning the agricultural product, agreement to binding dispute resolution, governing legal jurisdiction, and similar. The listings object 36 stores values 160 of the predefined attributes 140, as received from or selected by the terminals 24. Some values 160 may be set to be immutable, such as attributes that define the legal context of the contract.

The listings object 36 is also configured to support calculated or other derived values. An estimated value 158 can be calculated based on values of predefined attributes 140, such as quantity 144 and unit price 146 for display at terminals 24 and for use as an initial payment amount prior to delivery, and post-delivery adjustments if deemed necessary. For example, a deposit amount can be an enterable monetary value or a calculated monetary value based on an entered amount per unit (e.g., dollars per head) or other basis. The deposit secures the contract before the initial payment (e.g., full, unadjusted payment) for the shipment is made. The deposit provides comfort to buyer and/or seller that the other party is committed. The deposit is a negotiable amount that can be an attribute of the structured negotiation.

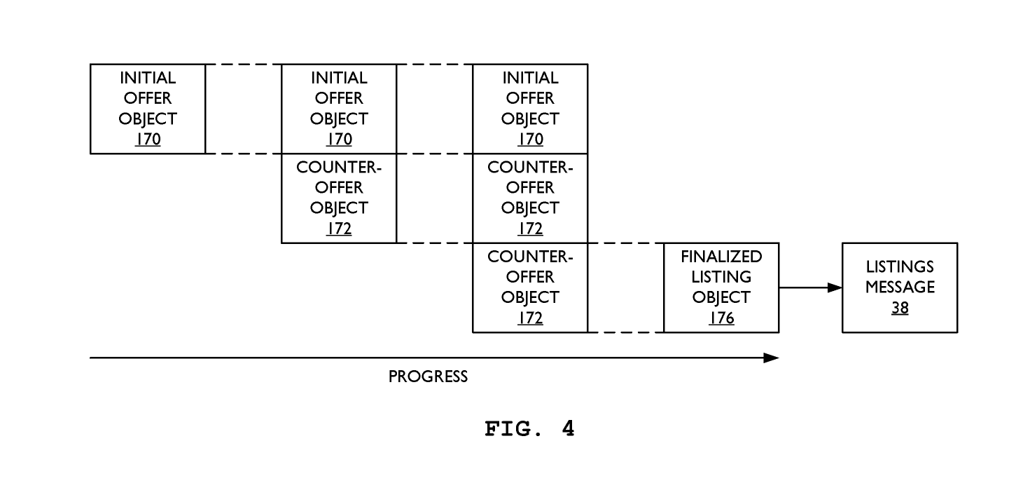

FIG. 4 shows a diagram of an example structured negotiation between parties at terminals 24 as facilitated by the system 10. A listings object 36 (FIG. 3) progresses from initial listing to finalized contract during negotiations. An initial offer object 170 is created by a party and represents the initial listing of the agricultural product for purchase or sale. Subsequent to initial listing, a counteroffer object 172 targeting the initial offer object 170 may be created by a counter party. Any number of counteroffer objects 172 can be associated with an initial offer object 170, and it is expected that each such counteroffer object 172 originates from a competing counter party at a different terminal 24. The original party may create a counteroffer object 172 in response to one of the initial counteroffer objects 172, and subsequent counteroffer objects 172 may be alternately created by each negotiating party. Counteroffer objects 172 are automatically populated with values from the immediate parent object, so that only data that is subject to negotiation need be received from the terminals 24. At any stage, the most recent object 170, 172 may be accepted by the receiving party (i.e., the party that did not create the object) as a finalized listing object 176 representative of the final contract for purchase and sale of the agricultural product. A structured negotiation thus progresses, in which differences between the objects 170, 172 converge to arrive at an agreement or otherwise fail to converge resulting in no agreement. At the end of the structured negotiation, a listings message 38 indicative of the finalized listing object 176, and subsequent binding contract, is generated and sent to the payment processing system 16.

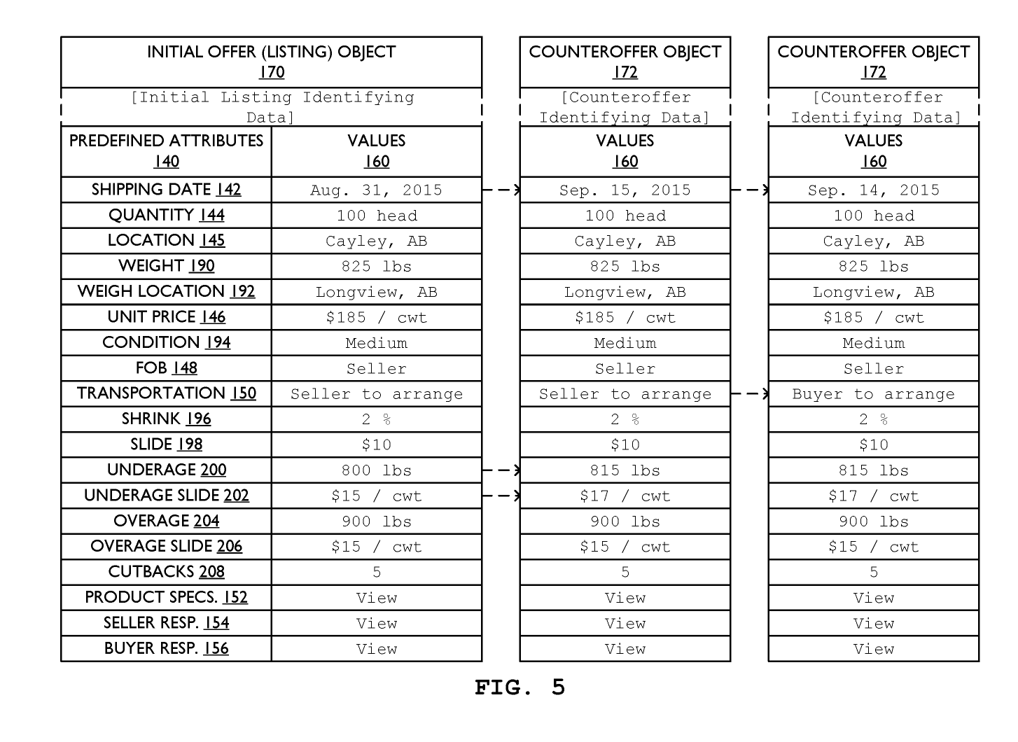

During the structured negotiation, initial offer and counteroffer objects 170, 172 are displayed adjacently at relevant terminals 24. That is, the objects 170, 172 can be arranged so that values of each predefined attribute are aligned. This is shown in FIG. 5. An initial offer object 170 and corresponding counteroffer object 172 are displayed at terminals 24 with predefined attribute values aligned. Subsequent counteroffer objects 172 can also be displayed in this aligned manner. Changes to predefined attribute values can be highlighted (see the arrows in FIG. 5) using font bolding, colour, or similar.

Also shown in FIG. 5 are example predefined attributes specific to cattle as an agricultural product. The exchange of cattle is a salient example of the present invention, as the market is diverse, presently heavily dependent on inefficient manual processes, and may be difficult for participants to navigate and discover. The predefined attributes include quantity 144 as a number of head, individual weight 190 (nominal, average, etc.) as a numerical value, location where the cattle are to be weighed 192 as a geographic location, unit price 146 in currency amount per hundredweight, condition 194 as a selectable descriptor, shrink 196 as a percentage, slide 198 as a currency amount, underage 200 as a numerical value of weight, underage slide 202 in currency amount per hundredweight, overage 204 as a numerical value of weight, overage slide 206 in currency amount per hundredweight, and cutbacks 208 as a percentage or units (e.g., head). Other predefined attributes (not shown) can include type (e.g., heifers), breed (e.g., Angus), biological data (e.g., British, Continental/Exotic), colour, frame scores, weigh condition, shrink, transportation instructions, and transport company details. Still further predefined attributes within the scope of the present invention will be apparent to those of ordinary skill in the art having the benefit of this disclosure.

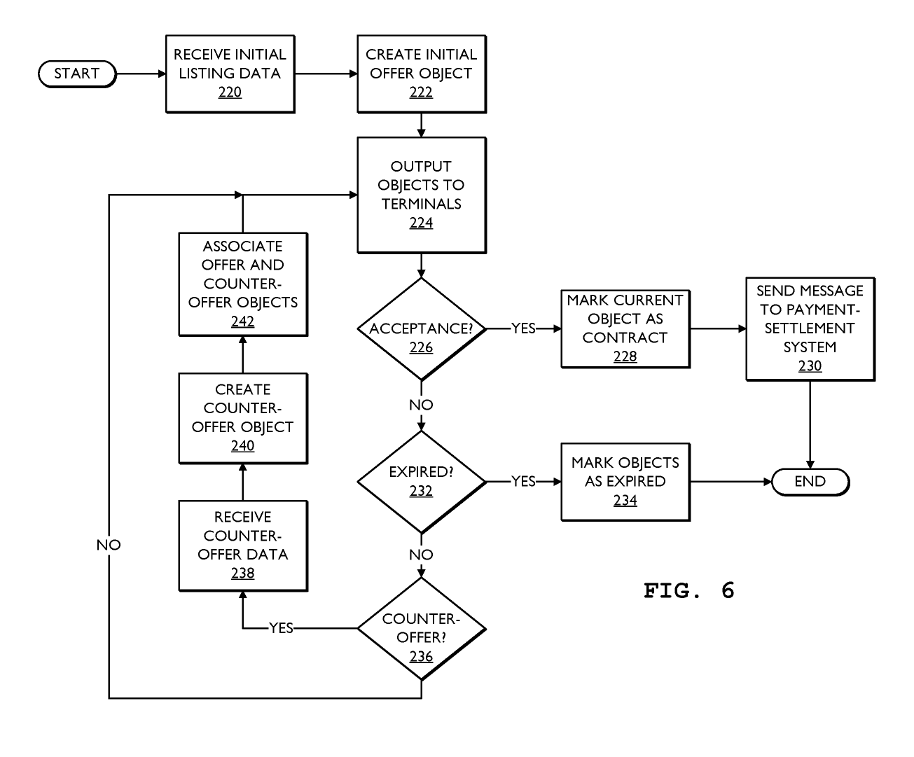

FIG. 6 shows a flowchart of a process for the structured negotiation described above. The process can be performed by the listings system 12 (FIG. 1), and particularly by the listings engine 32. However, reference to the example systems/engines is not intended to be limiting.

At step 220, data for an initial listing is received. An initial offer object is created, at step 222. The initial offer object, as well as any associated counteroffers are outputted to the terminals 24, at step 224, as shown in FIG. 5, for instance. Step 226 determines if an acceptance indication has been received for the most recent of the initial-listing and counteroffer objects from a terminal 24 associated with the party that received the most recent of such objects. If the most current of the initial-listing and counteroffer objects has been accepted, such object is marked as a finalized binding electronic contract, at step 228, which can include updating the status and/or intent of the object. At step 230, a listings message 38 is then sent from the listings system 12 to the payment-settlement system 16. The listings message 38 contains at least a subset of the data of the object marked as the finalized binding electronic contract, and particularly the data relevant for processing a payment between the parties. The data relevant for processing a payment can include identifiers of the buyer and seller, as well as an amount for the initial payment, which can be calculated by the listings engine 32 using the relevant attributes (e.g., quantity 144, weight 190, and unit price 146). In some examples, the listings message 38 can contain all of the data of the object marked as the finalized binding electronic contract.

When an acceptance indication is not received at step 226, expiry of the listing is checked, at step 232. If the listing has expired, the associated initial offer and counteroffer objects are marked as expired for eventual deletion or archiving, at step 234. Expiry time can be configured as extendible, as mentioned above, and step 232 can include sending a notification to the owner of the listing to prompt for extension of the expiry time or otherwise adjust the listing.

If the listing is still active, an indication of a counteroffer may be received from a terminal 24, at step 236. While no such indications are received, the process returns to step 224 and repeats. When an indication of a counteroffer is received from a terminal 24, data for such counteroffer is received from the terminal 24, at step 238, and a counteroffer object is created, at step 240. When step 238 receives counteroffer data from the creator of the initial offer object, this indicates that the creator is further countering a counteroffer received on the initial offer. In such case, step 238 may also include locking the initial offer object against responding to counteroffers from other parties, so as to maintain the negotiation between only two parties (i.e., the creator of the initial offer object and the originator of the counteroffer being countered by the creator). At step 242, the newly created counteroffer object is then associated with the most immediate parent object, on which it is based and to which it refers, such that all objects relevant to the listing are associated and the negotiation history is preserved. The process then returns to step 224, outputting the newly associated object, and repeats.

One output of the negotiation process, when successful, is a listings message 38 that is sent to the payment-settlement system 16, at step 230. The payment-settlement system 16 is configured to create a payment-settlement object 48 in response to receiving such message and to process payment for the exchange of the agricultural product using the payment-settlement object 48.

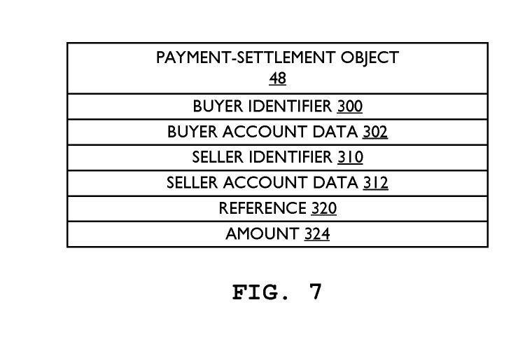

An example payment-settlement object 48 is shown in FIG. 7. The attributes shown are examples and more or fewer attributes can be used. The payment-settlement objects 48 may be stored in a relational database, in which objects are stored in rows and tables. Alternatively, a NoSQL database may be used.

A buyer identifier 300 identities the paying party and a seller identifier 310 identifies the beneficiary. The buyer identifier 300 and seller identifier 310 can be automatically populated based on data in the listings object 36 and communicated via the listings message 38. This determination can be made at either system 12, 16.

Buyer account data 302 and seller account data 312 contain the relevant account information for use by the relevant financial service system 22. Account data 302, 312 can include account numbers, transit numbers, bank codes, and/or similar and may be pulled from the accounts database 44 when the payment-settlement object 48 is created.

A reference 320 identifies the object at the listings system 12 that is marked as the finalized binding electronic contract. Instead of or in addition to the reference 320, pertinent values from the object at the listings system 12 can be populated in the payment-settlement object 48, as communicated via the listings message 38.

An amount attribute 324 numerically stores the actual amount of the payment. The amount is calculated by the listings engine 32 and communicated in the listings message 38 for the payment-settlement engine 42 to enforce. The amount attribute 324 may be further configured, or additional amount attributes may be provided, to store various additional amounts, such as a commission-free amount, a tax amount, and similar.

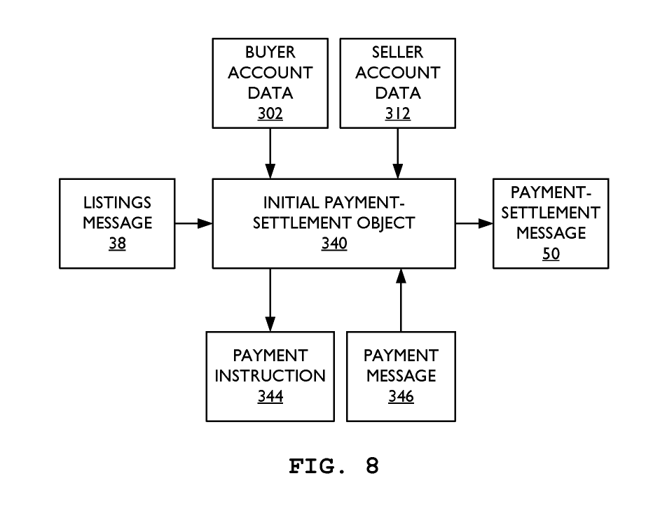

FIG. 8 shows a schematic diagram of the payment-settlement engine 42 handling a payment. A listings message 38 triggers creation of an initial payment-settlement object 340 for the initial payment for the agricultural product. Such a listings message 38 can be triggered by acceptance of a finalized listings object 176 (FIG. 4) as the binding contract. Buyer and seller account data 302, 312 is pulled from the accounts database 44 and stored in the object 340. The payment-settlement engine 42 generates and sends one or more payment-settlement messages 50, which are transmitted to the listings system 12 for updating, for example, the status of the underlying listings object. Payment-settlement messages 50 can include acknowledgements or error notifications in response to listings messages 38, as well as forwarding of payment confirmations or denials from the financial service systems 22. Upon execution, the payment-settlement engine 42 generates a payment instruction 344 and transmits the payment instruction 344 to the relevant financial service systems 22. Upon receiving a message 346 confirming payment success from the relevant financial service systems 22, the payment-settlement engine 42 generates a payment-settlement message 50 indicating that payment has been made and sends the payment-settlement messages 50 to the listings system 12, which generates and sends notifications to the relevant parties. Such a notification can include a notification to the buyer and seller parties that payment has been confirmed and that shipping of the agricultural product should be undertaken.

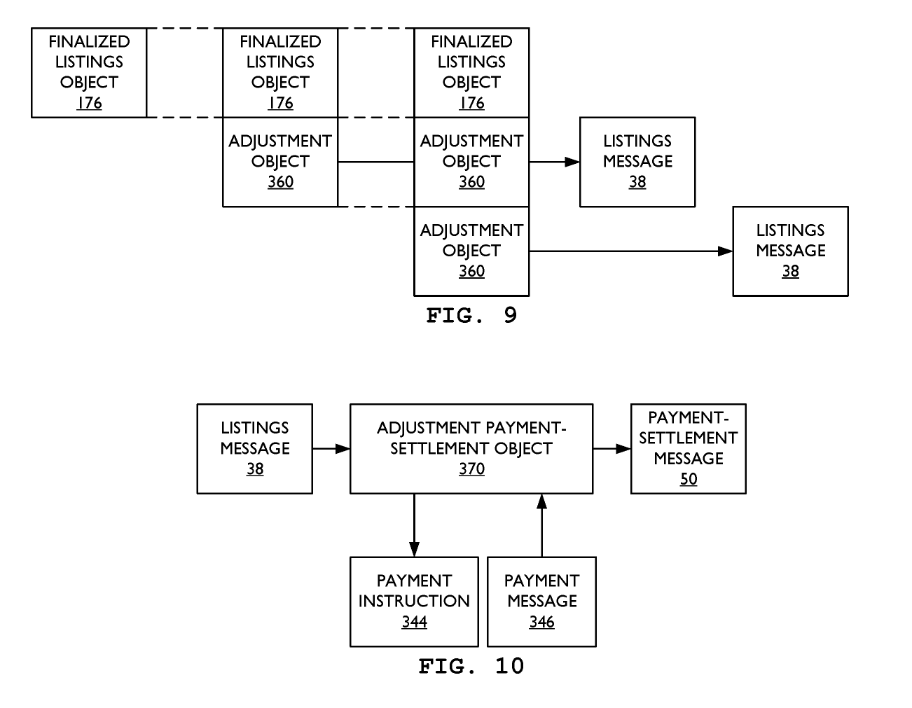

FIGS. 9 and 10 illustrate a post-delivery adjustment process. The process can be performed by the listings system 12 (FIG. 1), and particularly the listings engine 32. However, reference to the example systems/engines is not intended to be limiting.

Adjustment objects 360 are created to define delivered attributes of the agricultural product after or during delivery. Delivered attributes represent the differences in the product as actually delivered versus what was listed. Delivered attributes may be quantitative or qualitative and therefore possibly subjective. Examples of quantitative delivered attributes include quantity, kind, breed, weight, and various numerical values. Examples of qualitative delivered attributes include color, condition, and similar.

An initial adjustment object 360 is created at a terminal 24 operated by a buyer of the agricultural product. The adjustment object 360 is based on the listings object 36 (FIG. 3), and values for one or more attributes can be entered as one or more delivered attributes. For example, suppose the condition of cattle sold was described as “Medium” in the finalized listing object 176. The buyer of the cattle may evaluate the condition of the cattle upon delivery as “Poor”. The buyer then accesses the terminal 24 and creates an adjustment object 360 associated with the finalized listing object 176. The adjustment object 360 specifics that the received cattle have a condition of “Poor”. Subsequent adjustment objects may be created by the buyer or seller for the same or different predefined attributes, such that the process may be considered a structured negotiation for one or more adjustments.

The listings engine 32 is configured to receive or calculate an adjustment value for one or more adjustment objects 360. Received adjustment values are received from terminals 24 operated by the parties to the sale as proposed monetary values while the adjustment is negotiated. Received adjustment values can also be received by a terminal 53 operated by the administrator. Calculation may be performed automatically by the listings engine 32 based on values of other predefined attributes in the finalized listing object 176, based on historic data 74, or manually adjusted by the administrator based on the information received from both parties. A calculated adjustment value may be presented to the parties as suggested values for the adjustment. Alternatively, a calculated adjustment value may be used as an arbitrated value. Ultimately, an adjustment value is agreed by the parties, whether arbitrated or not.

At any point in the adjustment process, a listings message 38 reflecting an adjustment object 360 can be sent to the payment-settlement system 16 for generation of an associated payment-settlement object 48. It is contemplated that each adjustment object 360 results in a corresponding listings message 38 that triggers a corresponding adjustment payment.

With reference to FIG. 10, the payment-settlement engine 42 can be configured to respond to listings messages 38 specifying adjustments by creating an adjustment payment-settlement object 370 which has similar or the same structure as the payment-settlement object 48 shown in FIG. 7. Payment-settlement messages 50 associated with the adjustment payment-settlement object 370 can be returned to the listings system 12. Further, the payment-settlement engine 42 can generate and send payment instructions 344 to process adjustments in the same or similar manner as described for initial payments with respect to FIG. 8. For any one or combination of an initial payment-settlement object 340 and an adjustment payment-settlement object 370, the payment-settlement engine 42 can generate a payment instruction 344 and transmit the payment instruction 344 to the relevant financial service systems 22, so as to make payments to sellers. This may include an automated process, an admin managed process, or a combination of such.

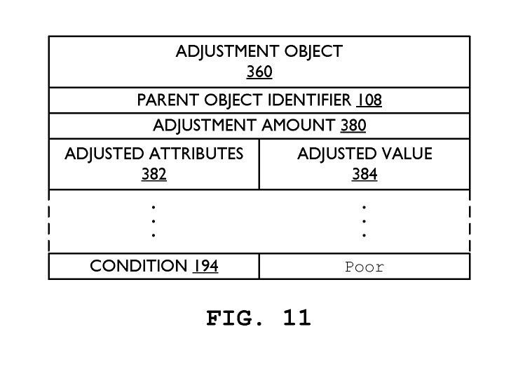

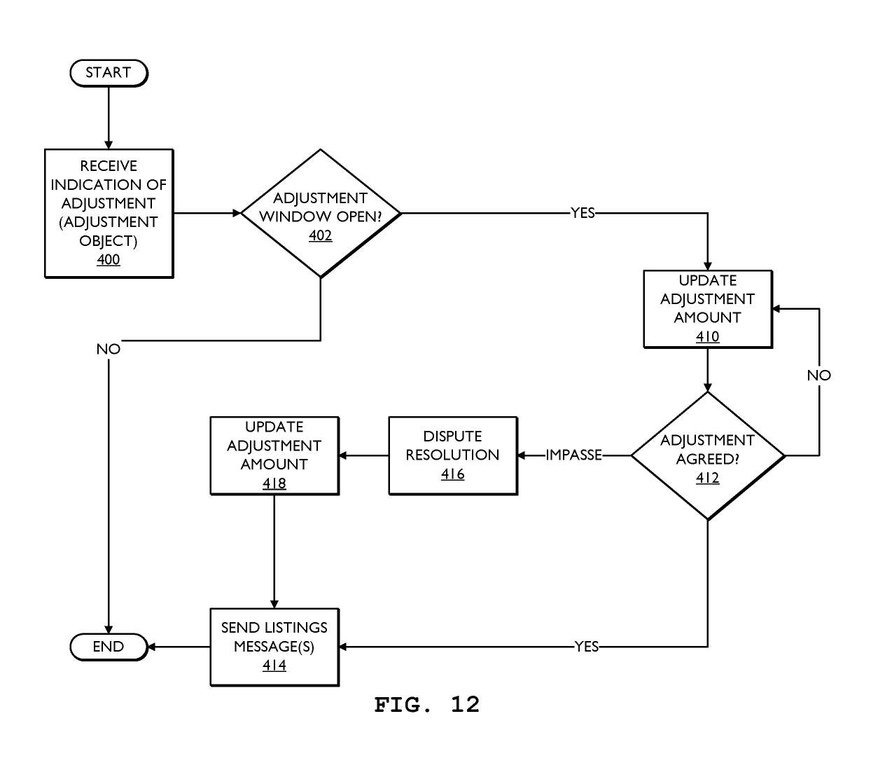

FIG. 11 shows an example of an adjustment object 360. The adjustment object may be based on the listings object 36, with an intent 104 specifying an adjustment, or may have a distinct data structure. The adjustment object 360 includes parent object identifier 108 for association with the finalized listing object 176 representing the contract. Each adjusted attribute 382, which is one of the predefined attributes, specifies an adjusted value 384 representing the delivered attribute behind the adjustment. An adjusted attribute 382 specifying a quantity (e.g., number of head) of product affected by the adjustment may be specified or made a mandatory input so as to advantageously permit adjustments based on less than the entire shipment. For instance, only a few head of cattle may be of worse condition than the agreed condition for the sale of a large number of head. Further included, is an adjustment amount 380, which is specified or calculated as discussed above. The adjustment amount 380 may be further configured, or additional amount attributes may be provided, to store various additional amounts, such as a commission amount, a tax amount, and similar.

FIG. 12 is a flowchart illustrating the post-delivery adjustment process. The post-delivery adjustment process occurs after a binding electronic contract has been formed between parties based on an initial listings object, as modified by any counteroffers, as described with respect to FIG. 6. The post-delivery adjustment process can be performed by the listings system 12 (FIG. 1), and particularly the listings engine 32. However, reference to the example systems/engines is not intended to be limiting. It is contemplated that, by this time, initial (unadjusted) payment for the agricultural product has been made and confirmed.

An indication of an adjustment is received at step 400. The adjustment indication can be realized by a terminal 24 asserting to the listings system 12 that an adjustment is requested through the creation of an adjustment object 360 (FIG. 11). The adjustment indication can serve as an indication of successful delivery of the agricultural product, and an adjustment object 360 without any adjusted attributes 382 can serve as a simple indication of successful delivery. If the adjustment window closes before an adjustment indication is received, then the process ends and no adjustment is possible. The adjustment window may be time limited (e.g., 5 days after delivery), event limited (e.g., acceptance of prior adjustment, release of payment), or both. Further, it may be assumed that delivery is successful unless a buyer terminal 24 provides an indication that delivery was unsuccessful. Alternatively, the buyer terminal 24 may be required to specify an adjustment indication even if only to acknowledge delivery. In such case, the adjustment window is configured to not close for adjustment indications that specify no adjusted attributes 382.

The terminal 24 requesting the adjustment can provide at least one value for a delivered attribute of the agricultural product. As discussed above, the delivered attribute maps to at least one of the predefined attributes of the finalized listing object 176.

An adjustment amount 380 is determined, at step 410. The adjustment amount may be automatically calculated by the listings engine 32 based on values of other predefined attributes. For example, if the contract is for 100 head of cattle and only 99 were delivered, as indicated by the delivered attribute, then the calculation can be an incremental adjustment of a total amount due. A similar calculation applies for weight and other quantities attributes. In another example, if the condition of the cattle is disputed, then the calculation can be based on a more complicated algorithm, which may reference historic data 74 for matching or substantially matching contracts. Other calculations within the scope of the present invention will be apparent to those of ordinary skill in the art having the benefit of this disclosure. Calculation results may be presented as a suggested adjustment amount 380 that can be overridden by input at a terminal 24, or may be presented as a fixed, unalterable amount.

The adjustment object 360 is presented to the other party, via a notification from the listings system 12, for instance. When the adjustment object 360 is agreed by the other party, at step 412, the process proceeds to send a listings message 38, at step 414, to the payment-settlement system 16 for generation of a respective payment-settlement object 370 and corresponding payment instruction 344 for payment of the adjustment amount. Step 414 may also be configured to trigger closing of the adjustment window, checked at step 402, to prevent piecemeal adjustments.

If the adjustment is not agreed, an alternative value for the delivered attribute may be provided by the disagreeing party resulting in the creation of another adjustment object 360, or modification of the existing adjustment object 360, and the updating of the adjustment amount, at step 410. It is contemplated that after an initial adjustment object 360 is created by a buyer, the seller may dispute the adjustment or provide a compromise. The buyer may then agree or further modify the adjustment. The iterative negotiation process defined by steps 410, 412 is repeated until a final adjustment is agreed or until an impasse is reached.

Step 412 checks for an impasse, which can be defined as detection of a specific number of adjustment objects 360 relating to the same predefined attribute, non-convergence of values of a series of adjustment objects 360, exceeding a length of time allotted for resolving an adjustment, explicit indication from a terminal 24 that an impasse has been reached, or some combination of these criteria.

When an impasse has been reached, a dispute resolution process 416 is performed. The dispute resolution process can include an industry expert at a terminal 24 communicating with the parties in dispute and selecting a final, binding value for the adjustment amount 380, automatic or human-triggered enforcement of an automatically calculated value of the adjustment amount 380, or similar. The adjustment amount 380 resulting from the dispute resolution process 416 is set at step 418, and the process advances to step 414 to send a listings message 38 to the payment-settlement system 16 for generation of a respective payment-settlement object 370 and corresponding payment instruction 344 for payment of the adjustment amount.

The process of FIG. 12 is performed for each adjustment, and it is contemplated that various scenarios may have several adjustments at different times. On the other hand, the adjustment object 360 (FIG. 11) is capable of handling a complex adjustment with many adjusted values 384 possible for various adjusted attributes 382, and scenarios are also contemplated where only a single adjustment is made, be it concerning one or more than one adjusted attributes 382. Once all adjustments have been processed according to the process of FIG. 12, ultimate settlement is reached.

Adjustments are performed after processing of initial payment, such that a series of payments on the same contract may be made. A dispute resolution may at times result in the requirement for the buyer to provide additional funds to settle the adjusted contract value. In this instance, a payment-settlement message 50 is sent from the payment-settlement system 16 to the listings system 12 to trigger a notification to the relevant terminal 24 requesting additional funds from the buyer. Once the buyer has submitted these funds, the status of the contract is modified allowing the payment owing to the seller to be released, and notification to both parties is sent indicating the contract is now complete. It is also contemplated that a buyer may overpay (e.g., the delivered quality and/or quantity may be lower than agreed), in which case the system facilitates an adjustment payment from the seller to the buyer.

Payment is released to the seller upon completion of adjustments and any needed dispute resolution, upon acceptance of delivery from the seller with no adjustments, or upon deemed delivery made by operators of the system. Partial payments to the seller are contemplated for portions of the delivery that are not affected by adjustments. Hence, an adjustment negotiation may only affect a portion of a delivery and funds may only be withheld from the seller for such portion until such adjustment negotiation is completed. This can advantageously allow for quicker payment to sellers, on average.

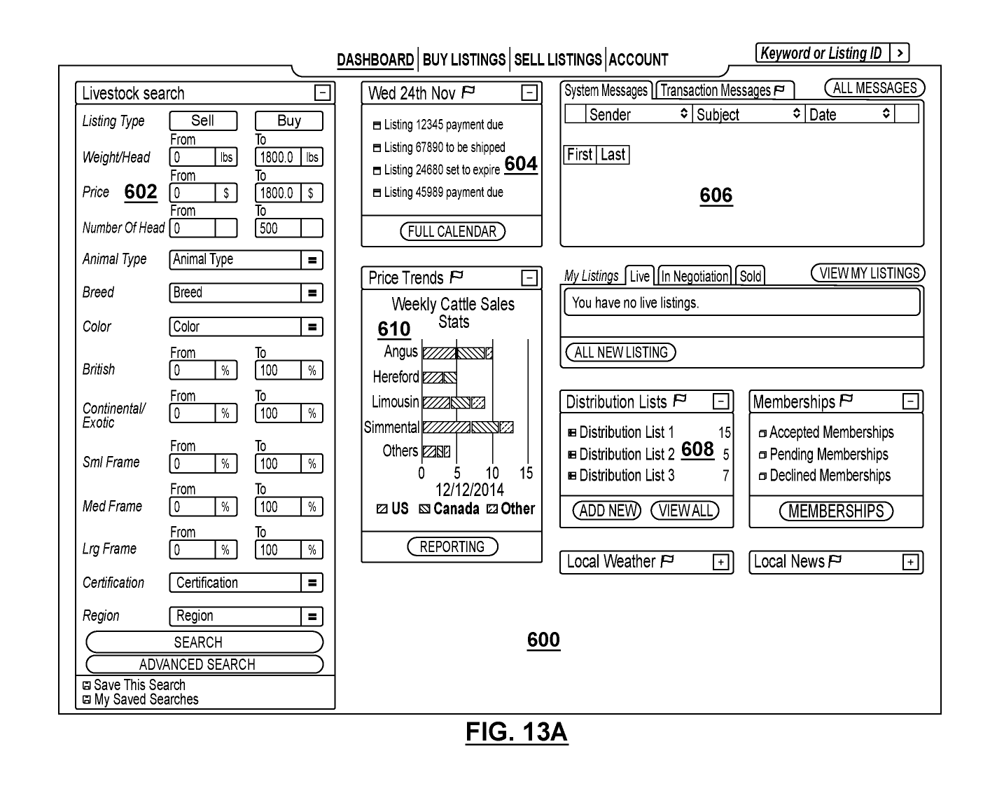

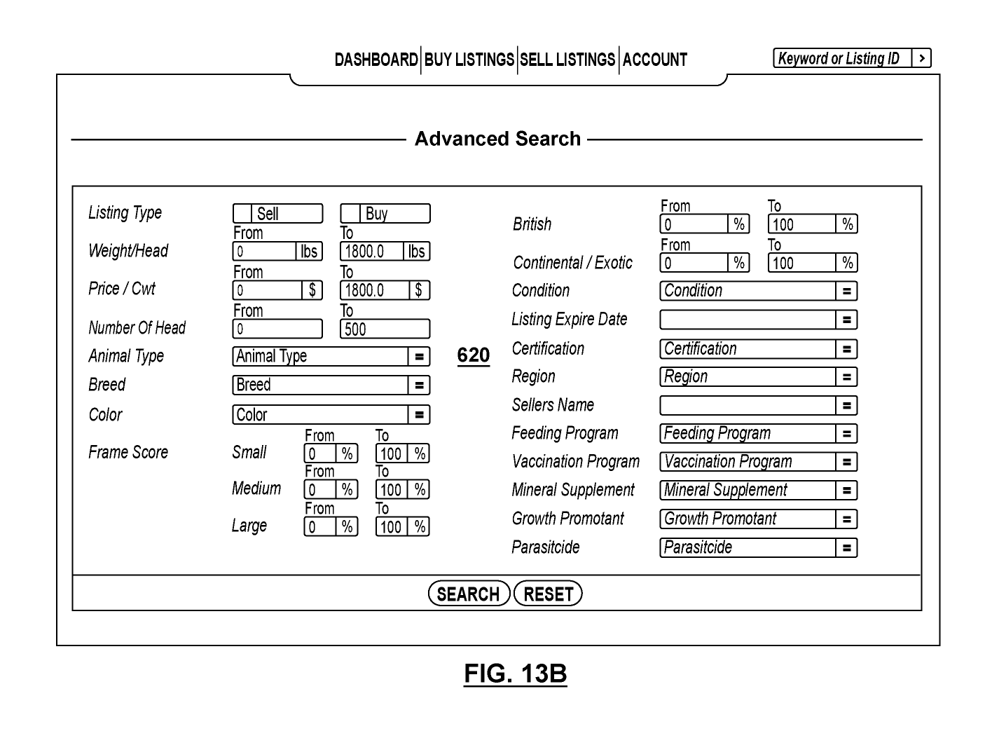

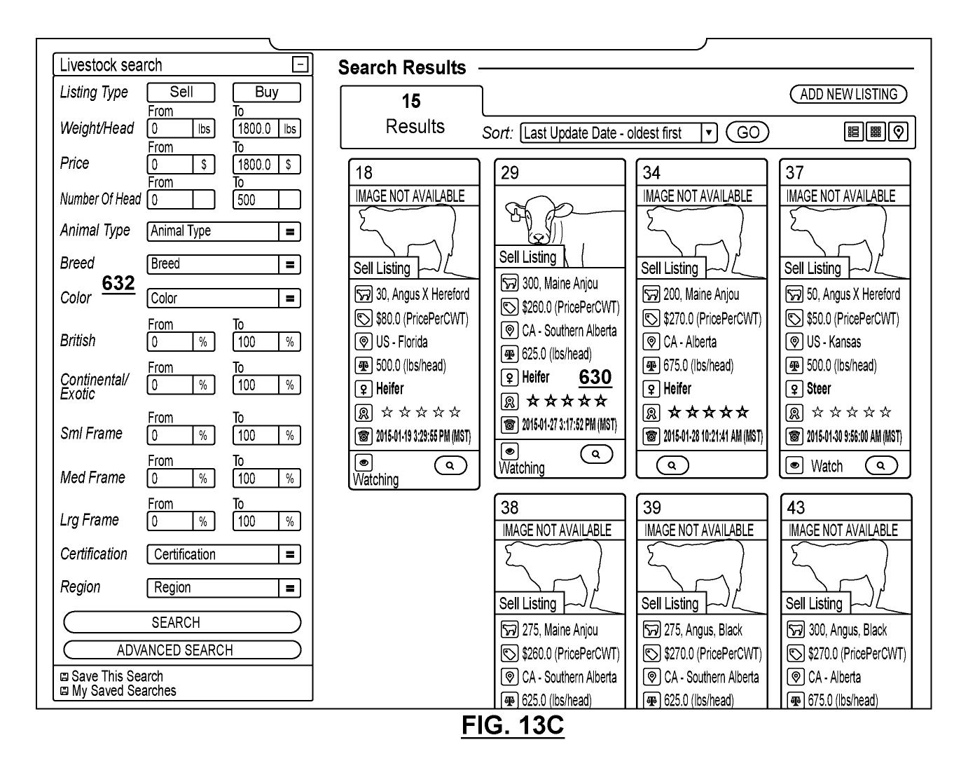

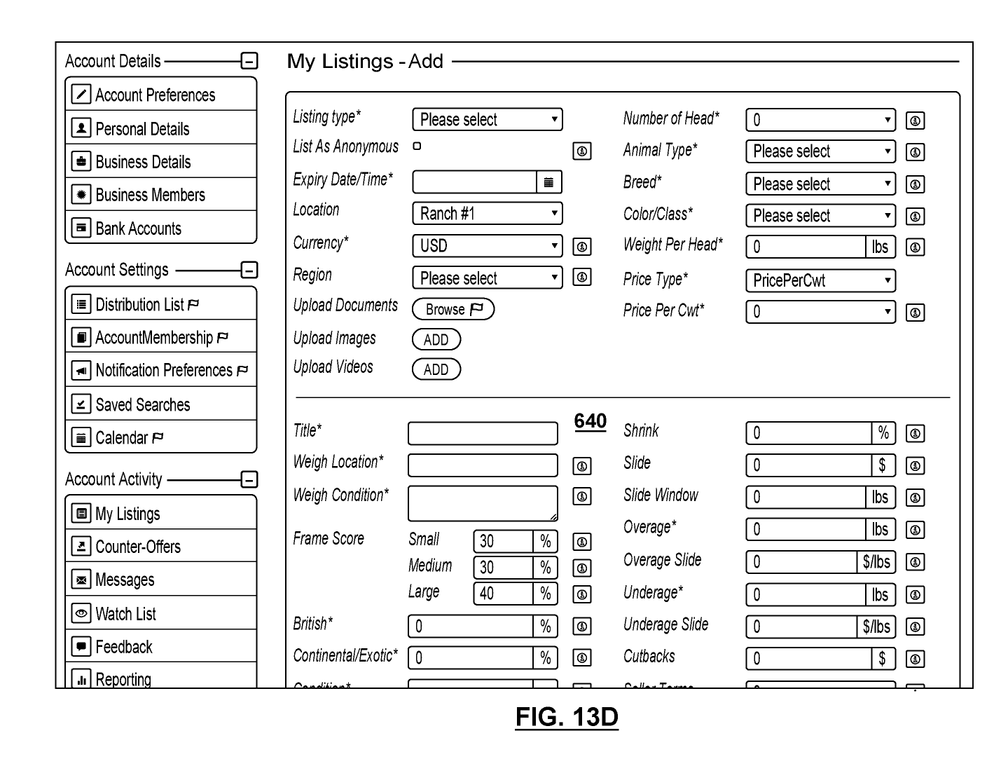

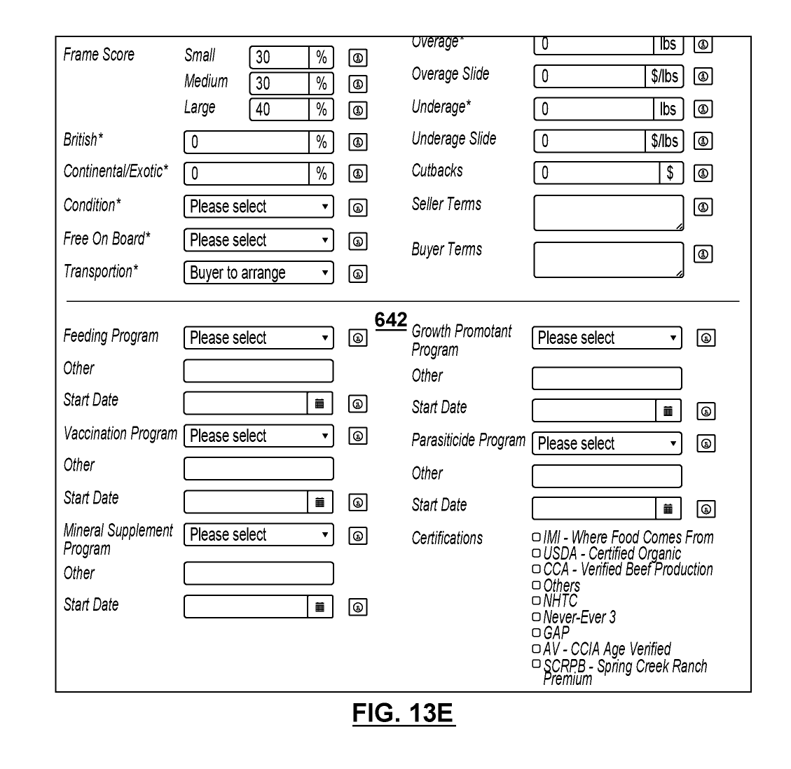

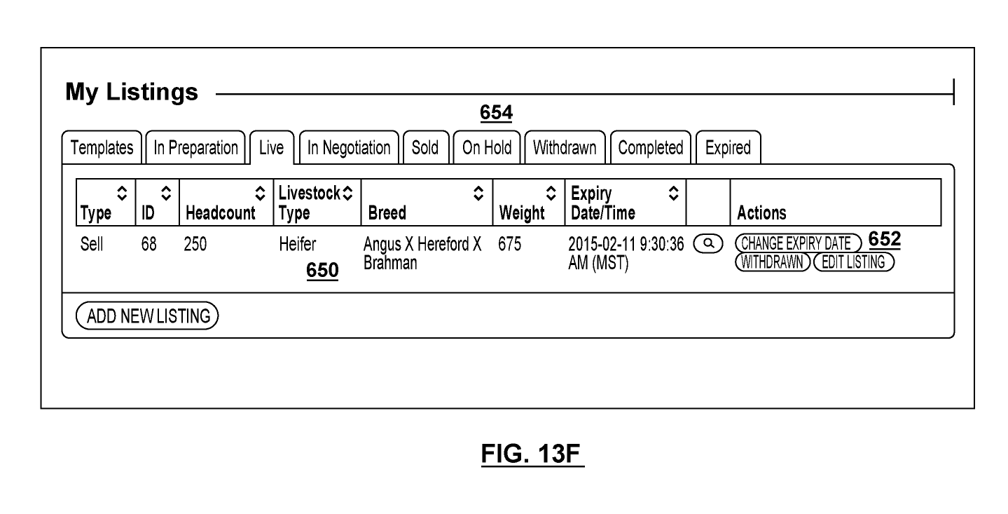

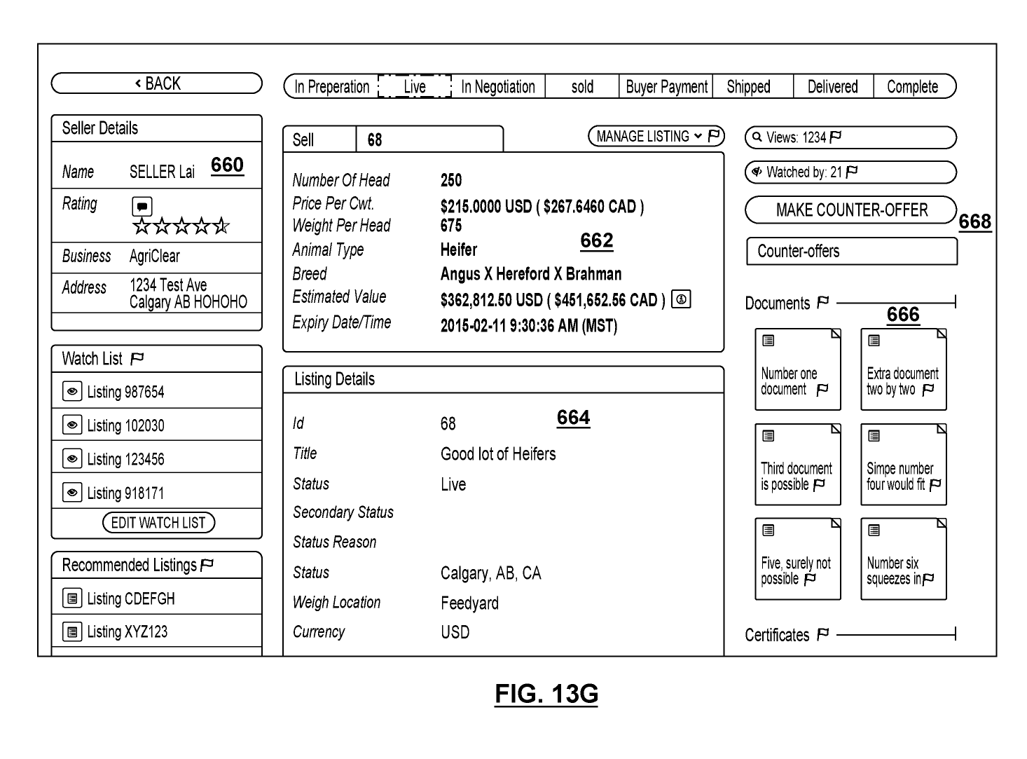

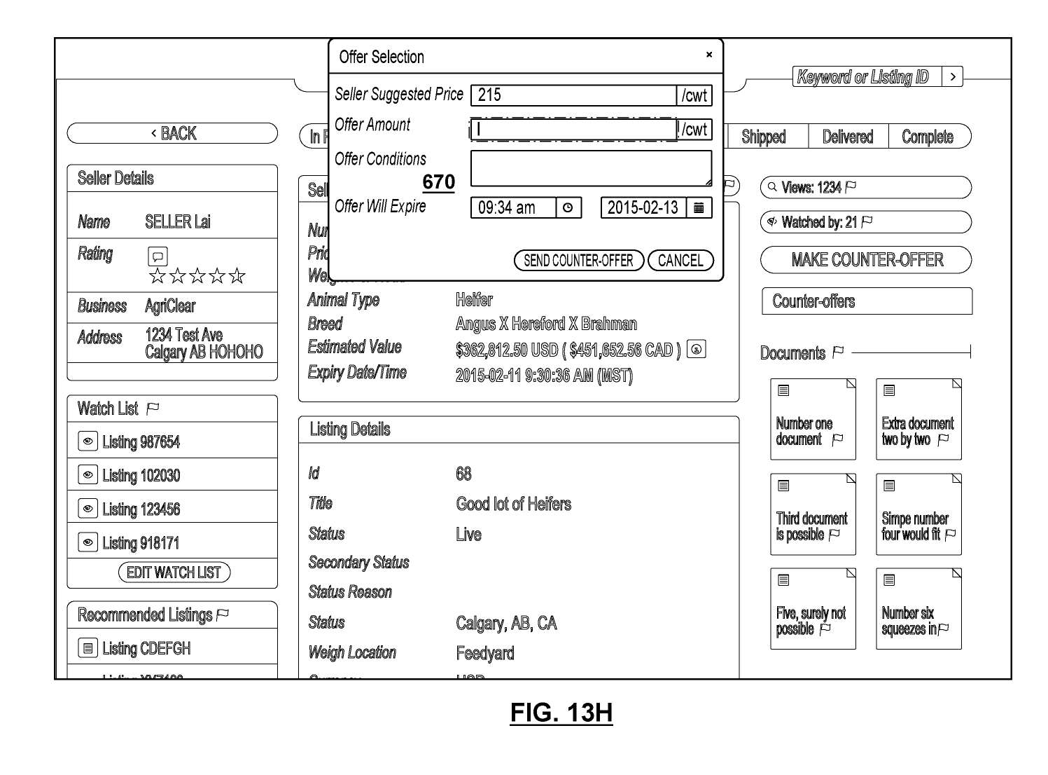

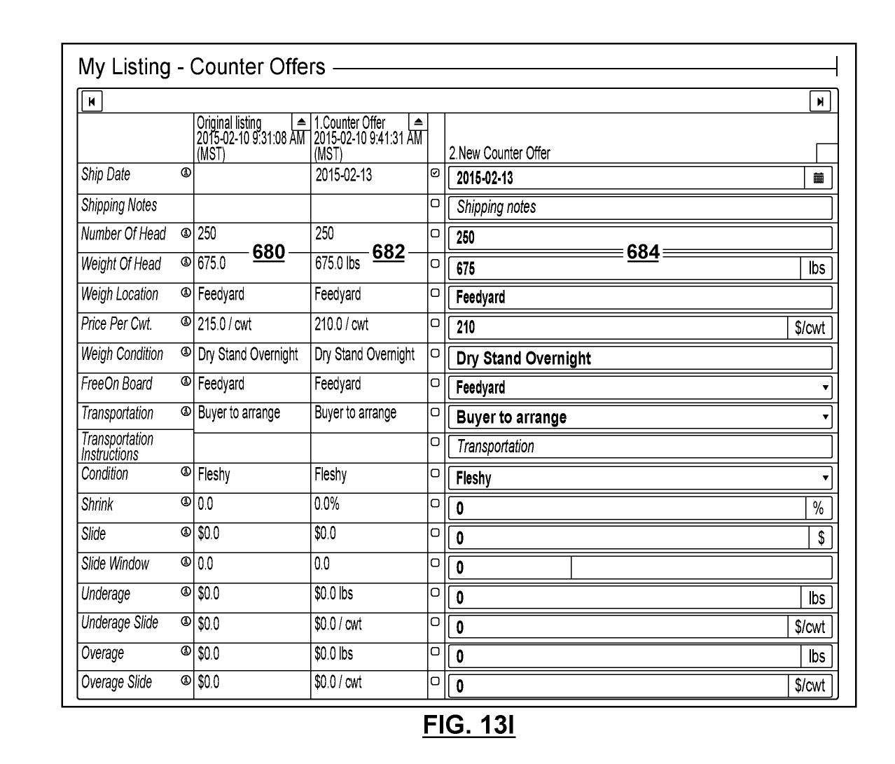

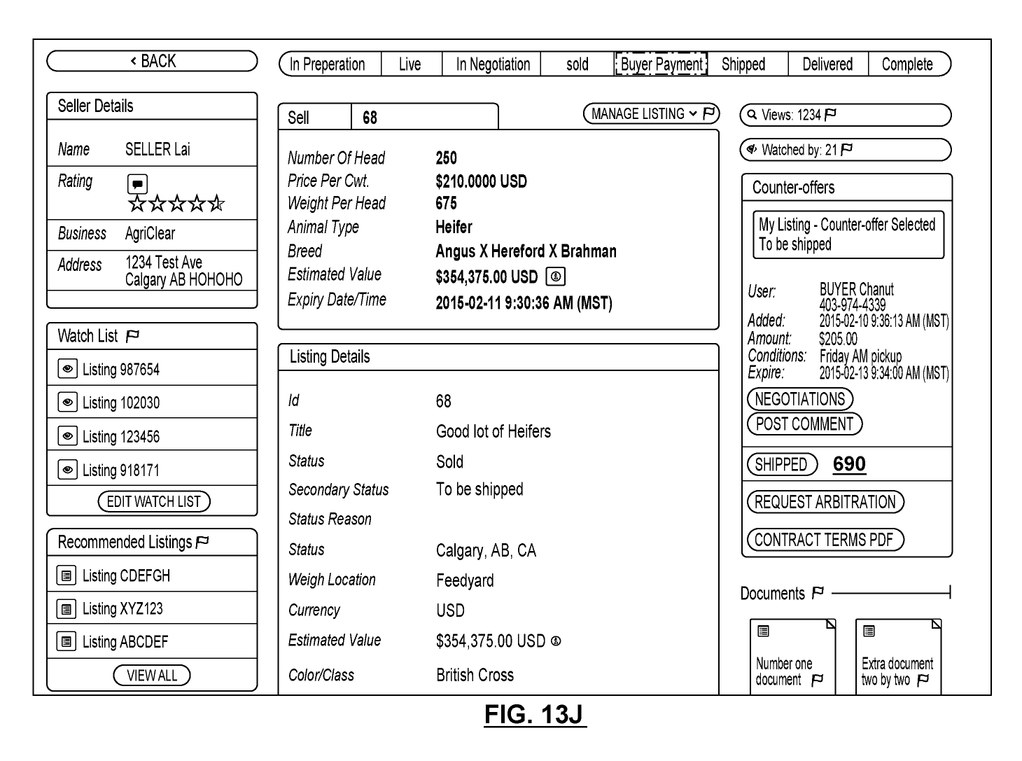

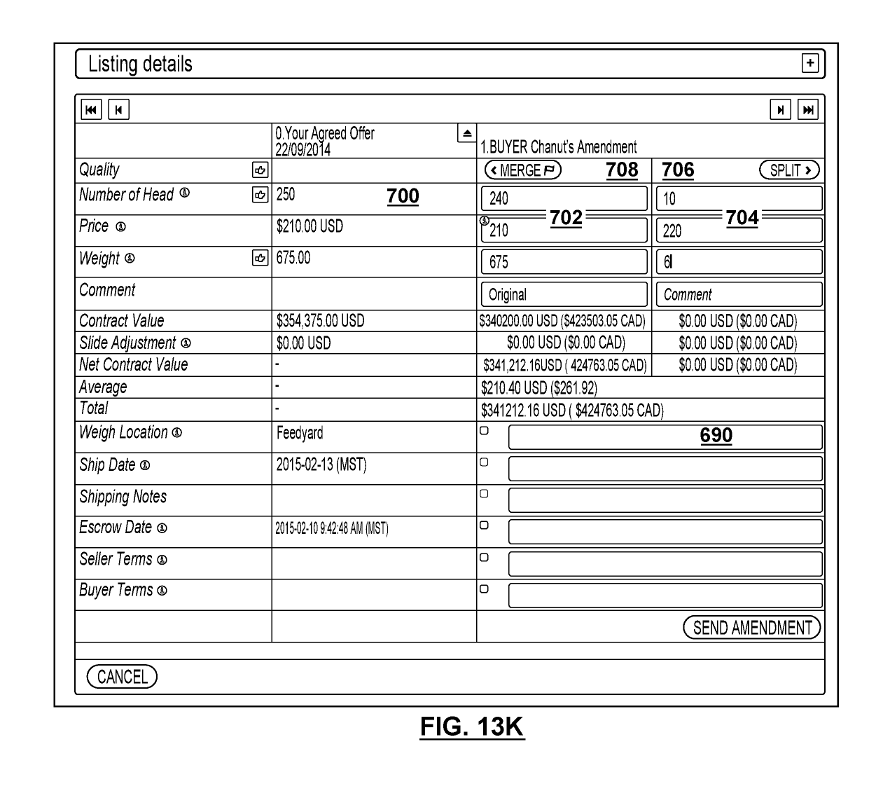

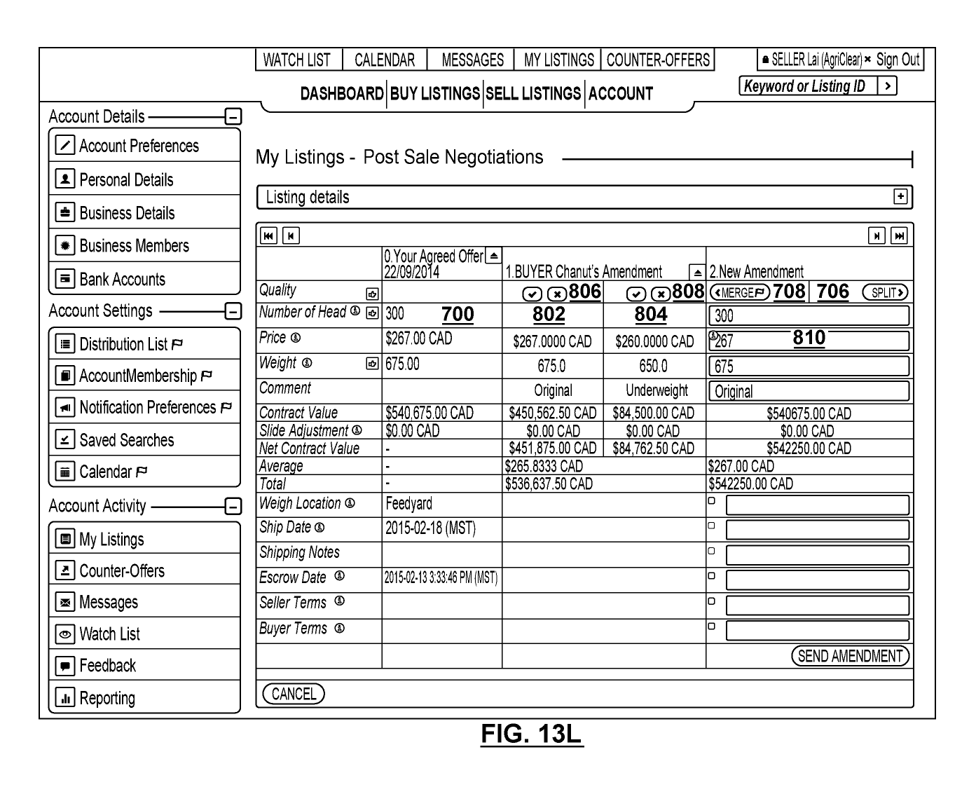

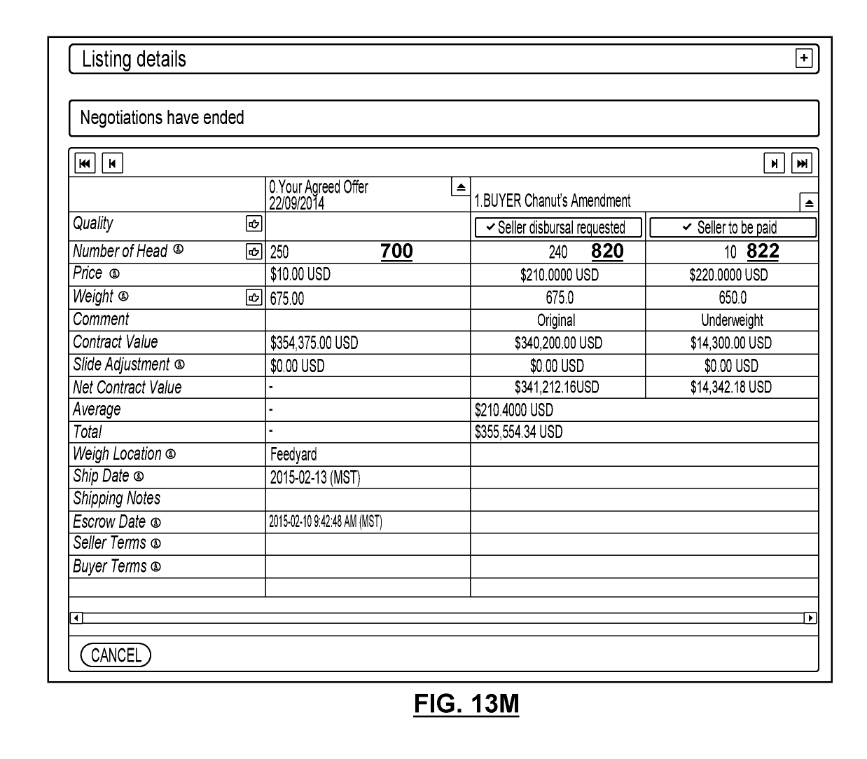

FIGS. 13A-13M show example user interfaces, as generated by the listings system 12 and as viewed at terminals 24.

FIG. 13A shows a dashboard 600 that includes a search entry form 602 communicatively linked to the search engine 78 (FIG. 2), a calendar panel 604 communicatively linked to the calendar engine 84 (FIG. 2), a message center 606 communicatively linked to the user notification engine 80 (FIG. 2), a distribution lists interface 608 communicatively linked to the listing presentation engine 82 (FIG. 2), and a price trend interface 610 communicatively linked to historic data 74 (FIG. 2).

FIG. 13B shows an advanced search entry form communicatively linked to the search engine 78 (FIG. 2) for user entry of attributes 620 to form a query for a search of listings.

FIG. 13C shows a search results interface communicatively linked to the search engine 78 (FIG. 2) for output of individual listings results 630 showing key attributes of the product. A search entry form 632 is also provided to enter or refine the query.

FIGS. 13D-13E show a new listings entry form showing listings input elements 640, 642 for user entry of attributes of the product to be offered for sale or purchase.

FIG. 13F shows a listings summary interface 650 that displays pertinent attributes of listings for a particular user, as well as user input elements configured to allow modifications to the listing, such as extending the expiry date, withdrawing the listing, and editing the attributes. Also shown is a status bar 654 showing tabs for status identifiers 110, as discussed above, where each status identifier tab can be actuated by the user to filter their listings based on status.

FIG. 13G shows a listings detail interface having a user panel 660 for information about the owner (seller or buyer user) of the listings and displaying key attributes 662 and detailed attributes 664 of the listing. A document summary and viewing panel 666 is provided to display certifications and other documents concerning the listing. A user input element 668 is also provided for a user to initiate a counteroffer on the listing.

As shown in FIG. 13H, actuation of the user input element 668 triggers display of a counteroffer input element 670 into which the user may enter attributes of the counteroffer, such as amount, conditions, and expiry time.

FIG. 13I shows a structured negotiation interface in which attributes 680 of the initial offer are presented side-by-side attributes 682 from one or more counteroffers. In addition, counteroffer input elements 684 are provided for quick entry of a further counteroffer, and such input elements can be prepopulated with attribute values of the most recent prior counteroffer. See also FIG. 5.

FIG. 13J shows the listings detail interface for a sold listing updated to include user input elements 690 for indicating shipping (seller), requesting arbitration (dispute resolution), and viewing the binding contract.

FIG. 13K shows a post-delivery negotiation interface displaying agreed pre-delivery attributes 700, as well as input elements 702, 704 for selecting adjusted attributes 382 (FIG. 11) and entering values 384 for such. Each set of input elements 702, 704 corresponds to one adjustment object 360 (FIG. 11), as a single delivery may require distinct adjustments that cannot be logically combined or that are more understandable when separated. A split input element 706 is provided for actuation by a user to add an additional set of input elements for a new adjustment object 360. A merge input element 708 is provided for actuation by a user to combine adjacent adjustment objects 360, thereby reverting to values of the adjustment object 360 having the highest amount or based on some other logic.

FIG. 13L shows the post-delivery negotiation interface displaying received adjustments 802, 804 and user interface elements 806, 808 for individually accepting or rejecting each of such adjustments. Further provided is a set of input elements 810 for entering a new adjustment object 360 (FIG. 11) to counter any rejected adjustments 802, 804. The input elements 810 are accompanied by merge and split input elements 708, 706, discussed above. The set of input elements 810 may also be used to enter an unrelated adjustment.

FIG. 13M shows the post-delivery negotiation interface displaying the original agreed contract attributes 700, amounts based on the original contract 820, and any finally agreed adjustment(s) 822 and final adjusted prices.

With the system and structured negotiation process for sale and adjustment having being described above, the processing of payments will now be described below.

With reference back to FIG. 1, the payment-settlement engine 42 is configured to respond to incoming payment messages 346 confirming incoming payments from buyers. Such incoming payment messages 346 (FIGS. 8 and 10) originate from the relevant financial service systems 22 and can take various forms. As triggered by an incoming payment message 346, the payment-settlement engine 42 generates a payment-settlement message 50 indicating that payment has been made and sends the payment-settlement messages 50 to the listings system 12, which generates and sends notifications to the relevant parties. Such a notification can include a notification to the buyer and seller parties that payment has been confirmed and that shipping or release of the agricultural product can/should be undertaken.

Incoming payment messages 346 can be received indirectly or directly by the settlement interface 46 of the payment-settlement system 16 from a financial service system 22 via the network 52. In one example, an administrator terminal 53 facilitates indirect communication of incoming payment messages 346 from the financial service system 22 to the settlement interface 46. This may include downloading incoming payment messages 346 from a financial service system 22, and uploading such incoming payment messages 346 to the payment-settlement engine 42. In another example, the settlement interface 46 directly communicates with the financial service system 22 using one or more APIs or other interface, so as to directly receive incoming payment messages 346 from the financial service system 22.

Incoming payment messages 346 can be received as payments occur or can be received in batches periodically. It is contemplated that the incoming payment messages 346 represent payments from buyers to a settlement account held at a financial service system 22. The settlement account can be a single settlement account for all buyer-seller transactions handled by the system 10. Outgoing payments to sellers may be made from the same single settlement account, as well, and such payments can be directed to sellers via seller account data 312 (FIG. 7). On the other hand, the methodology and schema of the incoming payment messages 346 is under the control of the relevant financial service systems 22 and may not specify buyer account data 302 (FIG. 7) that can be unambiguously matched to an actual buyer in the system 10. Hence, the payment-settlement engine 42 is configured to match incoming payment messages 346 to payment-settlement objects 48 and the buyer identifiers 300 (FIG. 7) thereof, so that transactions within the system 10 can be completed.

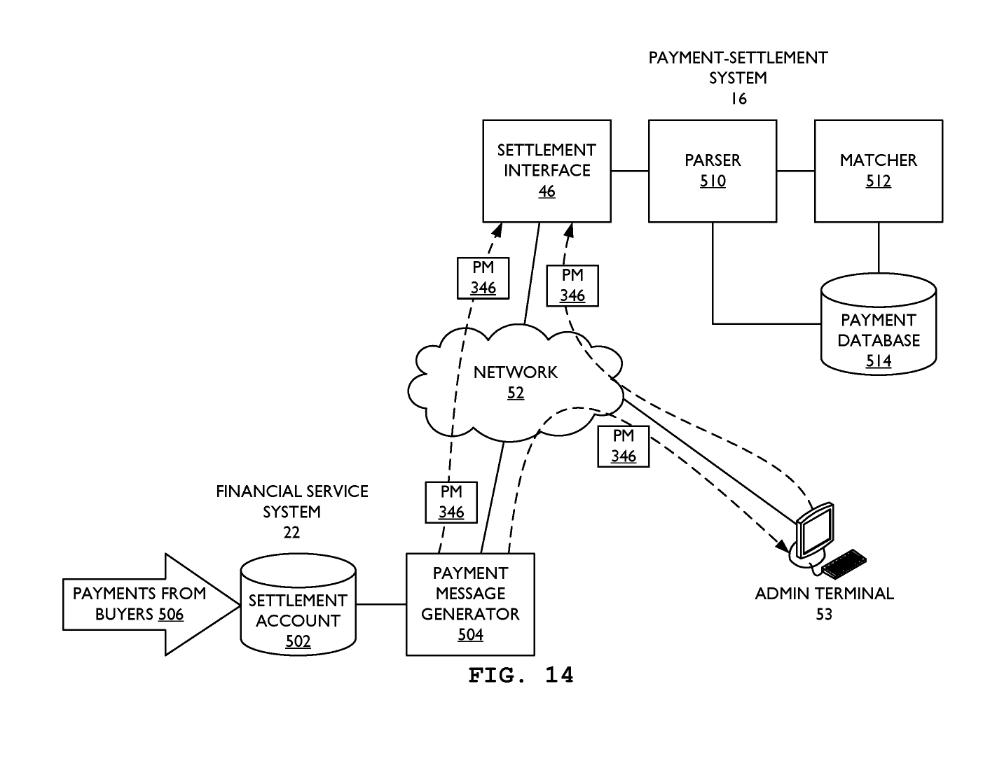

FIG. 14 shows a diagram of components of a financial service system 22 in communication with components of the payment-settlement system 16 via the network 52.

The financial service system 22 includes a settlement account 502 and a payment message generator 504. The settlement account 502 is controlled by the operator(s) of the system 10 and received payments from buyers 506 via various pathways, such as Electronic Funds Transfer (EFT), E-mail Money Transfer, Automated Clearing House (ACH) Payment, Wire Payment (Wire Transfer), Society for Worldwide Interbank Financial Telecommunications (SWIFT) payment, and similar. The settlement account 502 is associated with a database that tracks all transactions according to the methodology controlled by the financial service system 22.

The payment message generator 504 queries the settlement account 502 to obtain data of one or more transactions. This query may be performed periodically, may be performed as each transaction occurs, or may be performed at the command of an administrator terminal 53. In this example, the payment message generator 504 generates an incoming payment message 346 that identifies a batch of transactions within a predetermined time span. The batch of transactions may represent any number of payments to/from the settlement account. The payment message generator 504 can include a network interface component that is configured to communicate payment messages over the network 52.

As shown in FIG. 14, incoming payment message 346 can be sent directly from the payment message generator 504 to the settlement interface 46, or can be sent indirectly via an administrator terminal 53 that downloads the incoming payment message 346 from the payment message generator 504 and uploads same to the settlement interface 46.

The payment-settlement system 16 includes the settlement interface 46, a parser 510, a matcher 512, and a payment database 514. The parser 510 and matcher 512 may be part of the payment-settlement engine 42 (FIG. 1).

The parser 510 is connected to the settlement interface 46 and is configured to receive incoming payment messages 346 from the settlement interface 46. The parser 510 is further configured to parse incoming payment messages 346 into payment message records and store such in the payment database 514.

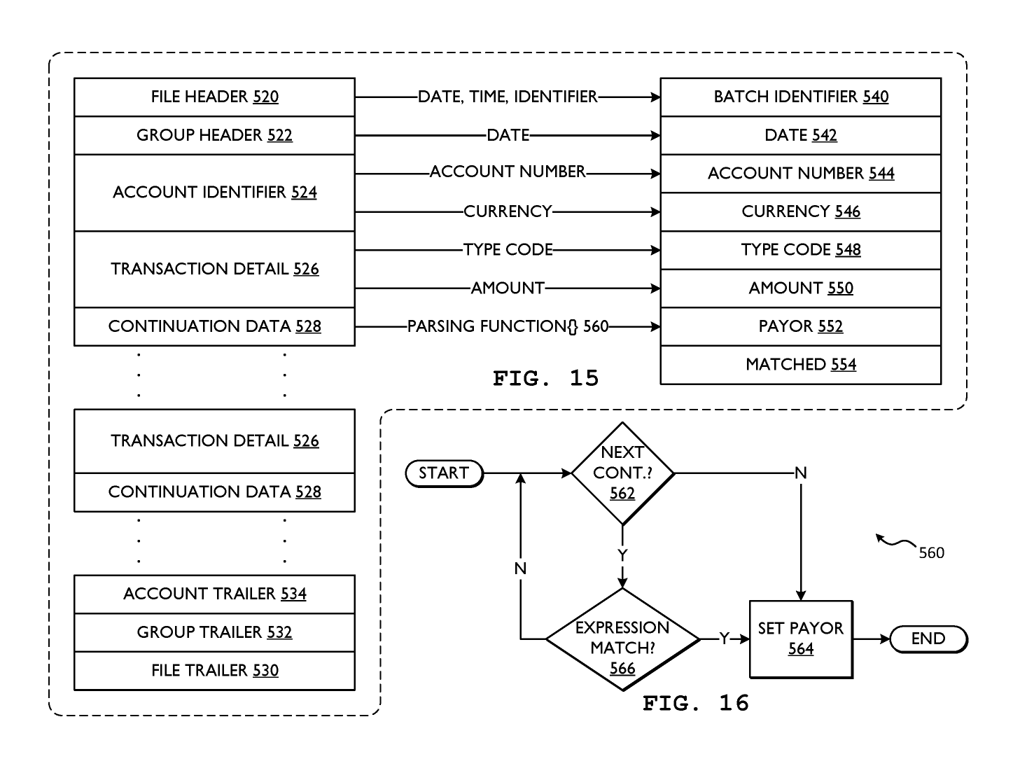

Parsing incoming payment messages 346 includes mapping data contained in the incoming payment messages 346 to the data structure of the payment database 514. In this example, the incoming payment messages 346 are formatted according to a payment message schema that defines serial lines of data containing comma-separated values. As shown in FIG. 15, the payment message schema defines lines such as a file header 520, a group header 522, and an account identifier 524, each with their respective trailers 530-534. The file header 520 uniquely identifies the incoming payment message 346 and the group header 522 identifies a group of account identifiers 524, each of which brackets any number of transactions. The payment message schema further defines transaction detail 526 and continuation data 528 for an account when located between the respective account identifier 524 and account trailer 534. Any number of continuation data 528 lines may follow a transaction detail 526 line. Each line 520-530 contains comma-separated values of predetermined data type, such as numeric and alphanumeric.

The parser 510 is configured to map the payment message schema to a payment message record definition for storing records in the payment database 514. The payment message definition defines fields including a batch identifier 540, a date 542, an account number 544, currency 546, a type code 548, an amount 550, a payor (buyer) 552, and a matched indication 554. Each element of data in the payment database 514 that accords to the payment message definition represents one payment.

An example mapping, depicted, maps the date, time, and file identifier in the message file header 520 to a batch identifier 540 in the payment database 514. The batch identifier 540 can be a unique ID, such as a combination of the date, time, and file identifier, a hash generated from such, or similar. The mapping further maps the date of the group header 522 to the date 542 of the payment as stored in the payment database 514. The account number and currency (USD, CAD, etc.) in the account identifier 524 respectively map to the account number 544 and currency 546 in the payment database 514. A type code (representing type of transaction, e.g., Wire Transfer, etc.) and amount in a transaction detail 526 respectively map to the type code 548 and amount 550 of the payment as stored in the payment database 514. The matched field 554 may be a Boolean value (true/false) that is initialized to false, meaning no match. Continuation data 528 is processed by a parsing function 560 with the result mapped to the payor field 552 in the payment database 514 for the respective payment.

The parsing function 560 is implemented by the parser 510 and is configured to parse continuation data 528, which may form any number of lines in an incoming payment message 346 and may contain a string of arbitrary alphanumeric characters.

FIG. 16 shows a flowchart of a process for the parsing function 560. For each transaction detail 526, the process iterates through lines of continuation data 528 until data suitable to populate the payor field 552 is obtained. At step 562, a next line of continuation data 528 is selected. Initially, if no line of continuation data 528 can be selected, then the parsing function 560 can return an error. If no next line of continuation data 528 can be selected, then the current line is used to populate the payor field 552, at step 564. For each line of continuation data 528, matching with one or more predefined expressions is attempted, at step 566. String comparisons, such as regular expressions, can be used. Predefined expressions indicate the presence of a payor name or other identifier in the line of continuation data 528 and can be, for example, strings such as “SENDING CO. NAME=”, “INFO=ORG=”, or similar. When an expression match has been made, the payor field 552 is set, at step 564. Step 564 sets as the payor field 552 a string adjacent an expression identified in the current line of continuation data 528, if coming from step 566, or sets as the payor field 552 the current line of continuation data 528 (of a predefined substring range thereof), if coming from step 562. The output of the parsing function 560 is setting the payor field 552 to a payor name/identifier contained in a line of continuation data 528, when an expression is matched, or to a best guess for the payor name/identifier, when an expression is not matched.

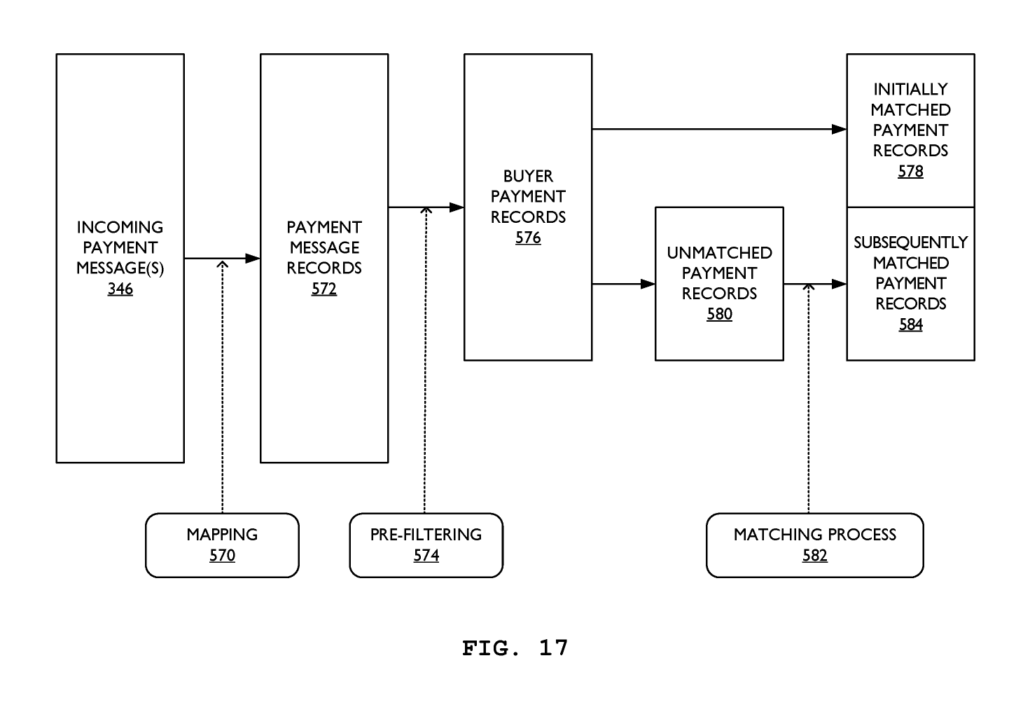

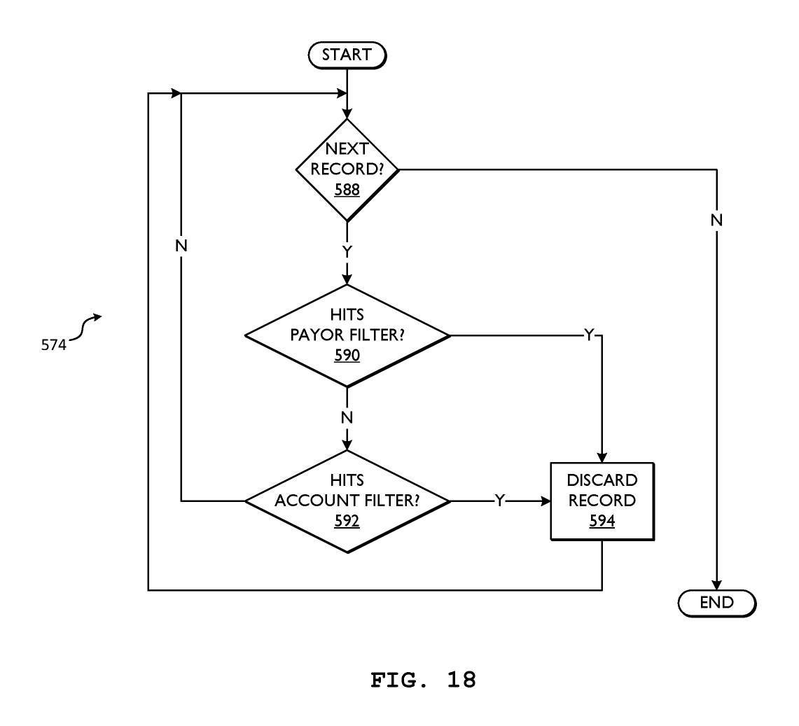

FIG. 17 shows the overall process for transforming incoming payment messages into matched payment records. Incoming payment messages 346 undergo mapping 570, as discussed above with respect to FIGS. 15 and 16, to obtain payment message records 572 that conform to the payment message record definition, discussed above, and are stored in the payment database 514.

The payment message records 572 undergo a pre-filtering process 574 to eliminate payments that cannot be attributed to buyers. The pre-filtering process 574 results in buyer payment records 576 that are attributed to buyers. Payment records not attributed to buyers may be discarded. The pre-filtering process 574 is shown in FIG. 18.

The mapping process 570 and the pre-filtering process 574 can be performed in any order and as distinct processes, as discussed, or as a single, combined process.

The buyer payment records 576 contain initially matched payment records 578 and unmatched payment records 580. Marking a buyer payment record 576 as matched can be achieved by, for example, the Boolean (true/false) matched field 554 in the payment message record definition (FIG. 15). Initially matched payment records 578 are those records whose payor field 552 contains a name/identifier identical to a buyer identifier 300 of a payment-settlement object 48, which originates from a buyer account name/identifier stored in user accounts data of the listings system 12. Additional checks can be implemented to qualify a buyer payment record 576 as an initially matched payment record 578.

Unmatched payment records 580 are those records whose payor field 552 contains a name/identifier differing from a buyer identifier 300 of a payment-settlement object 48, including the absence of a buyer name/identifier.

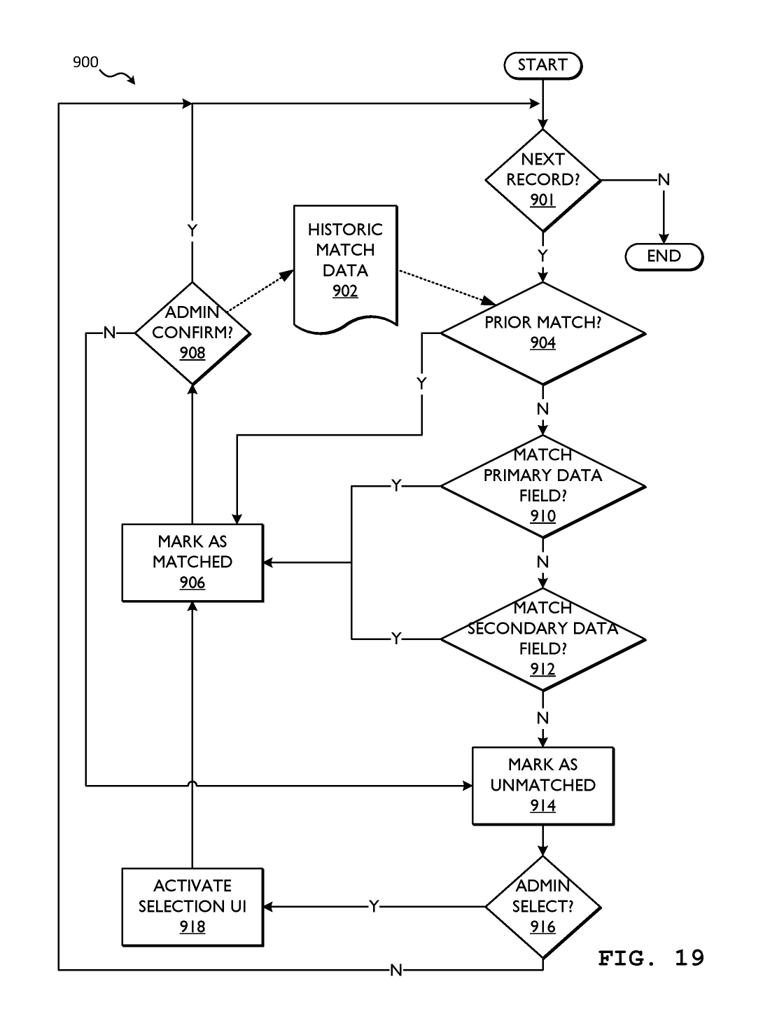

A matching process 582 is executed to process unmatched payment records 580 into subsequently matched payment records 584. The matching process 582 is shown in FIG. 19.

The pre-filtering process 574 and the matching process 582 can be performed by the matcher 512 shown in FIG. 14.

FIG. 18 shows the pre-filtering process 574. The process 574 iterates through all payment message records 572, via step 588. Each payment message record 572 is checked against a payor filter, at step 590, and an account filter, at step 592. Any payment record that meets a filter condition (i.e., hits the filter) is discarded or marked appropriately, at step 594. Once all payment message record 572 have been processed, and payment message record 572 remaining are taken to be buyer payment records 576.

Step 590 applies a payor filter that can, for example, exclude payment message records 572 whose payor fields 552 (FIG. 15) contain identifiers that unambiguously represent non-buyers. An example of such identifier is the name/identifier of the operator of the system 10, which may be present in the incoming payment messages 346 due to the operator making payments to sellers.

Step 592 applies an accounts filter that can, for example, exclude payment message records 572 whose account number fields 544 (FIG. 15) contain account numbers that unambiguously represent accounts that are not used to receive payments, such as accounts used for other purposes whose account numbers may not be provided to buyers.

FIG. 19 shows an example of a matching process 900 that can be used as the matching process 582.

The process 582 iterates through all unmatched payment records 580, via step 901. Each payment record 580 is checked against historic match data 902 for a prior match, at step 904. Historic match data 902 contains associations of data from payor fields 552 (FIG. 15) to buyer identifiers 300 (FIG. 7) based on previous matches made by the matching process 900. Step 904 determines whether the payor field 552 of the current payment record 580 matches any payor field 552 in historic match data 902, and is so, returns the associated buyer identifiers 300 as a match. The current payment record 580 is then marked as matched, at step 906, and, assuming no admin override at step 908, processing of the current payment record 580 ends and the next record is selected at step 901.

If no prior match was found in the historic match data 902, then the process attempts to match a primary data field to the payor field 552 of the current payment record 580, at step 910. The primary data field can be a data field maintained in the user accounts logic and data 72 (FIG. 1) and associated with payment-settlement objects 48 through a buyer identifier 300. That is, the primary data field stores an identity that a buyer may use when making payments or performing other business functions, but that is not identical to the buyer identifier 300. In this example, the primary data field is the buyer company's legal entity name. User accounts logic and data 72 data structures, such as a “Company” database table, can be queried based on the current record's payor field 552. If a match exists between the primary data field and the payor field 552 of the current payment record 580, then the current payment record 580 is marked as matched, at step 906.

If no match is determined on the basis of the primary data field, then the process attempts to match a secondary data field to the payor field 552 of the current payment record 580, at step 912. As with the primary data field, the secondary data field can be a data field maintained in the user accounts logic and data 72 (FIG. 1) and associated with payment-settlement objects 48 through a buyer identifier 300. That is, the secondary data field stores an identity that a buyer may use when making payments or performing other business functions, but that is not identical to the buyer identifier 300. In this example, the secondary data field is the buyer company's operational or “operating as” name. User accounts logic and data 72 data structures, such as a “Company” database table, can be queried based on the current record's payor field 552. If a match exists between the secondary data field and the payor field 552 of the current payment record 580, then the current payment record 580 is marked as matched, at step 906.

Other examples of data that can be checked as the primary and secondary data fields, or in addition to the examples given above for these fields, include user first name, user last name, transaction amount, and similar. Regarding transaction amount, the content of an amount field 550 (FIG. 15) of a payment record 580 can be matched to payment record 580 can be matched to the amount attribute 324 of a payment-settlement object 48. For each payment record 580, various different matches can be attempted using various different data fields, and a confidence value can be calculated based on the successful matches.

It is further contemplated that attempting matches of data fields can use pattern matching operators, such as LIKE and SIMILAR TO. This technique can be adapted to trigger matches irrespective of capitalization, minor typos/errors, abbreviations or omissions (e.g., dropping “Corp.” from a company name, or similar.

If no match can be determined through steps 904, 910, 912, then the current payment record 580 is marked (remains marked) as unmatched, at step 914. The process then proceeds to step 916, which sends a message to an administrator terminal 53 to prompt an admin to select a match. If the admin declines or does not respond, then processing of the current payment record 580 ends with the record 580 being unmatched, and the next record is selected at step 901. Unmatched records can be followed up outside of the process 900.

Upon affirmative response to the prompt, the process activates a buyer selection user interface, at step 918, that obtains a list of potential matches from, for example, user accounts logic and data 72 for the admin to browse and make a selection. Upon such selection, the current payment record 580 is marked as matched, at step 906.

For payment records 580 marked as matched, at step 906, to buyer identifiers 300 are obtained, if not already known. A match made via the primary or secondary data field in step 910 or 912 can trigger step 906 to query the user accounts logic and data 72 to obtain the buyer identifier 300 associated with the primary or secondary data field. Subject to admin confirmation, at step 908, each matched payment record 580 has the content of its payor field 552 and the associated the buyer identifier 300 written to the historic match data 902, if not already present, to facilitate future matches via step 904.

Any payment record 580 marked as matched by the process 900 becomes a subsequently matched payment record 584 (FIG. 17).

Each admin step 908, 916 is optional and can be omitted.

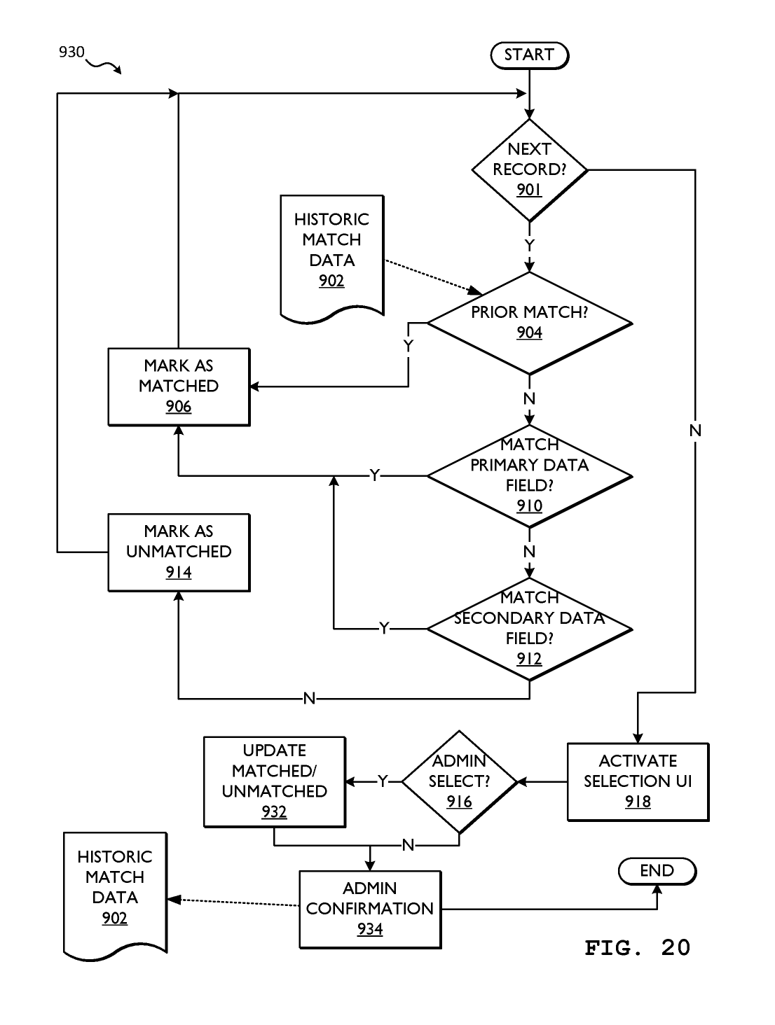

FIG. 20 shows another example of a matching process 930 that can be used as the matching process 582. The matching process 930 is similar to the matching process 900 and only differences are described in detail. Like reference numerals denote like steps and the above description can be referenced.

The process 930 iterates through all payment records 580, via steps 901 through 906/914, in a batch to mark records as matched or unmatched.

Once all records have been marked, buyer selection user interface, at step 918, is activated to allow an admin to select, at step 916, whether or not to alter a matched or unmatched state of any of the payment records 580. The buyer selection user interface can be configured to present a list of the payment records 580 including a checkbox or other user control that is linked to the matched field 554 (FIG. 15) of each payment record 580. In such example, the checking or unchecking of any one or more checkbox is determined at step 916.

Payment records 580 modified by the admin have their matched status updated at step 932 based on input at the buyer selection user interface.

After such update, if any, the process awaits confirmation from the admin, at step 934. Confirmation can be received by way of, for example, activation of a submit button or other user control that approves the entire list of payment records 580, including any changes made at step 932. After admin confirmation, each matched payment record 580 has the content of its payor field 552 and the associated the buyer identifier 300 written to the historic match data 902, if not already present in historic match data 902.

The systems and processes discussed above can be configured to automatically compute, collect, and remit marketing levies, which are also known as check-offs. Levies are collected from seller parties, typically, and remitted to the appropriate authorities (e.g., state/provincial organizations, such as beef councils or advisory boards, or governments). Levy amounts are often based on a number of factors, such as quantity, locations, and exemptions, and the determinations and computations discussed below account for such. Levies are tracked and aggregated separately from the underlying transactions for more efficient payment processing.

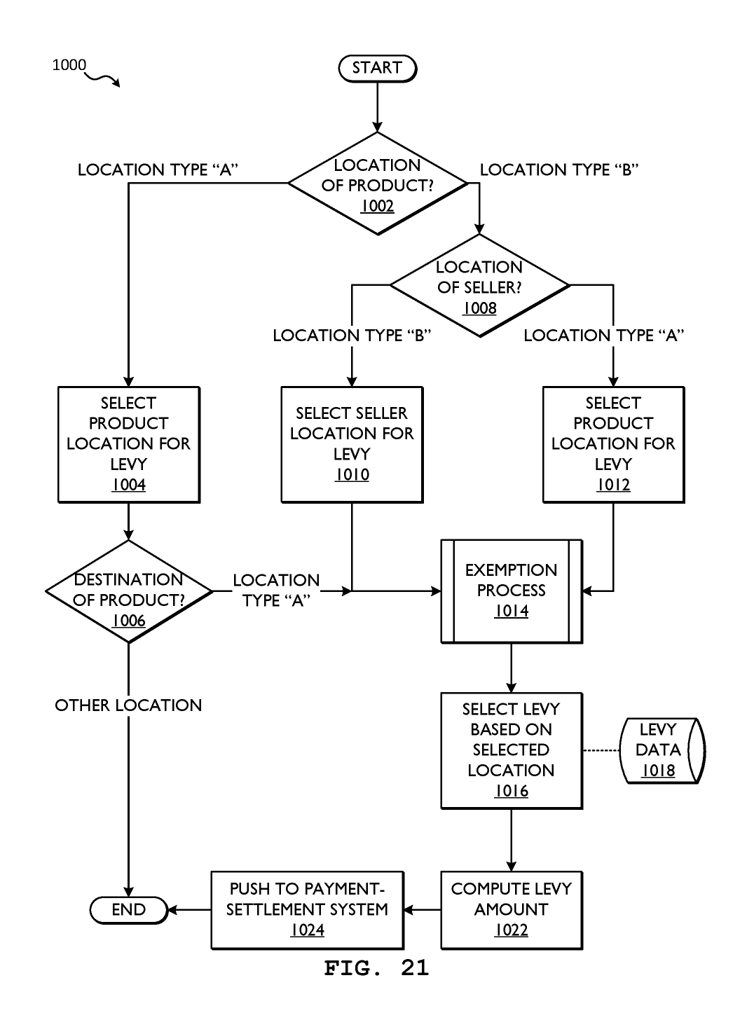

FIG. 21 shows a process 1000 for processing marketing levies. The process 1000 can be used with any of the systems and processes described elsewhere herein. The process 1000, as discussed below, is implemented at the listings system 12. The process 1000 can be triggered by an indication of the end of the structured adjustment negotiation process (FIG. 12), which finalizes agreement as to the actual quantity of product delivered and the actual origin and destination of the product. Alternatively, the process 1000 can be performed throughout the sale and post-sale negotiation processes.

Two types of locations are discussed as used with the process 1000. For a type “A” location, levies are primarily determined by the location of the product being sold, e.g., the location of the cattle when loaded for shipping. An example of a type “A” location is a state in the United States of America. For a type “B” location, levies are primarily determined by the location of the selling party. An example of a type “B” location is a province of Canada. Other countries/jurisdictions may fall into the type “A” and “B” categories or into other categories that are similar to the type “A” and “B” categories and thus fall within the scope of the process 1000. Further, more than two types of locations can also be implemented using the techniques described below.

At step 1002, the location of the product is determined. The geographic location 145 (FIG. 3) of a listings object 36 or adjustment object 360 can be referenced.

For product located at type “A” locations (e.g., a US state), the product location is selected for determination of the levy, at step 1004, and the shipping destination of the product (e.g., a state or province) indicated by the buyer is also referenced, at step 1006. When shipping from type “A” locations to type “A” locations, the process 1000 continues with the product location selected for determination of the levy. For other shipping destinations, such as a type “B” location (e.g., a Canadian province), the process 1000 ends and no levy is applied.

For product located at type “B” locations (e.g., a Canadian province), the location of the seller is selected for determination of the levy, at step 1008. A seller's address, such as a residence address, stored with the user accounts logic and data 72 (FIG. 1) can be referenced to make this determination. The user accounts logic and data 72 may be configured to require entry of a residence address or selection of province/state of residence. The user accounts logic and data 72 can be configured to take a seller's billing address or head-office address as a residence address for purposes of levy computation. The user accounts logic and data 72 can be configured to take a shipping address or the premises of the product in certain circumstances, such as cross-border transactions, as the address for purposes of levy computation.

For sellers located at type “B” locations (e.g., a Canadian province), the location of the seller is selected for determination of the levy, at step 1010.

For sellers located at type “A” locations (e.g., a US state), the location of the product is selected for determination of the levy, at step 1012.

The sub-process defined by steps 1002-1012 advantageously considers every relevant combination of product and seller locations in an efficient manner, without requiring input directly related to levies from the seller or buyer parties. This simplifies levy determination and reduces human error, which may result from the seller or other party having to make levy determinations manually.

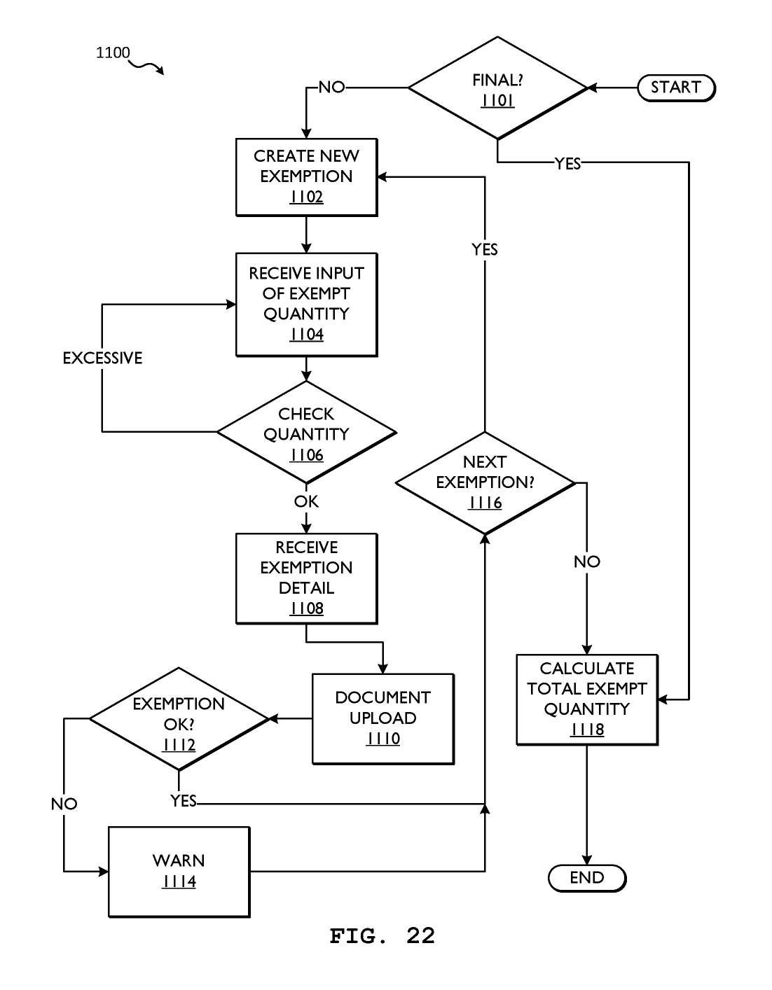

Once the location for levy determination has been selected, an exemption process (FIG. 22) is performed, at step 1014, to determine whether some or all of the product sold is exempt from levy. The output of step 1014 is a quantity of product that is exempt from levy.

After the exemption process, at step 1016, the appropriate levy is selected based on the location selected earlier (step 1004, 1010, or 1012). This can include referencing levy data 1018 stored at the listings system 12. Storing the levy data 1018 at the listings system 12 advantageously allows a computed levy amount to be modified by the seller and displayed to the seller. If the process 1000 is executed throughout the sale and post-sale processes, storing the levy data 1018 at the listings system 12 also beneficially allows updates of the levy amount to be made as the structured negotiation for sale takes place and as adjustments are negotiated and processed. It is a further benefit that the listings system 12 need not transmit intermediate levy amounts to the payment-settlement system 16.

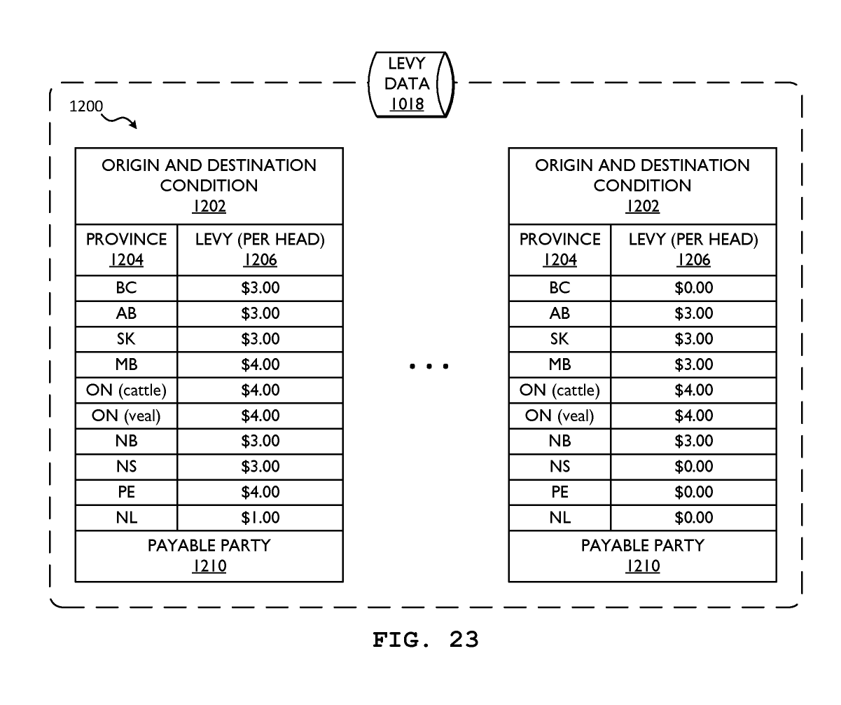

Levy data 1018 may include one or more tables (or other data elements) of levies and for associated locations. Levy data 1018 associates levies to the selectable locations from steps 1004, 1010, and 1012 and further associates levies to conditions, such as origin and destination locations for the product. FIG. 23 shows examples for cattle.

Then, at step 1022, the levy amount is computed and the payable party is determined. The levy amount is calculated based the levy data 1018 for the selected levy. For example, the selected levy may be a per-unit fee (e.g., $3.00 per head of cattle) and the levy amount may be calculated by multiplying the per-unit fee by the actual number of units delivered less the quantity of exempt units (from step 1014) specified by valid exemptions. Any other suitable type of financial calculation is also possible, as determined by the particular type of levy. Further, any applicable tax may be included in the levy calculation. The payable party is also determined from the levy data 1018.

Lastly, at step 1024, after the levy amount and payable party have been determined, such information is transmitted to the payment-settlement system 16. At the same time, other relevant information, such as the levy (per head amount) and quantity, may also be transmitted to the payment-settlement system 16. For a particular sale, the levy amount, payable party, and other relevant information are transmitted once. This eliminates the need for the payment-settlement system 16 to track non-finalized levies and thereby reduces communications between the payment-settlement system 16 and the listings system 12 to make the overall process more technically efficient. The payment-settlement system 16 collects the levy by subtracting the levy amount from the amount payable to the seller. A service fee for the payment-settlement system 16 paying the levy may also be deducted from the amount payable to the seller. The payment-settlement system 16 further remits the levy amount to the payable party, which may be batched or scheduled (e.g., once per month for the previous month) for improved payment processing efficiency. Hence, rather than multiple transactions to a payable party from multiple sellers at different times, there is one aggregated transaction for a particular payable party, which may serve to lessen communications and other processing stresses on the electronic payment systems involved.

FIG. 22 shows an exemption process 1100 useable with the levy determination process 1000 of FIG. 21. The process 1100 can be used with any of the systems and processes described elsewhere herein. The process 1100 as discussed below is implemented at the listings system 12 using, among other components, the document handling subsystem and document summary and viewing panel 666 (FIG. 13G).

Adding exemptions, and providing supporting documents to existing exemptions, can be performed at any time before settlement. The exemption process 1100 is asynchronous to the marketing-levy process 1000. Invocation of the exemption process at step 1014 of the marketing-levy process 1000 performs a final calculation for valid exemptions. At step 1101, it is determined whether this is the final calculation for valid exemptions. Is this is not the final calculation, then more exemptions can be added via step 1102. If this is the final calculation, then the total exempt quantity for all valid exemptions is determined at step 1118.

At step 1102, a new exemption is created for a particular sale, prior to the levy information being transmitted to the payment-settlement system 16. The seller can use the user interface of the listings system 12 to create the new exemption. The exemption can be stored at the listings system 12 as an object or data record associated with a particular listings object 36 (FIG. 3) representing the sale.

An indication of the quantity of exempt product is received, at step 1104, which may be part of the process of creating the new exemption. The indication of quantity can be entered by the seller through the user interface of the listings system 12. Not all of the sale need be exempt. In the example of cattle, the quantity may be a number of head.

A quantity check is performed at step 1106 to verify that the quantity entered for the current exemption does not exceed the quantity of the sale, as defined by the listings object 36 and any adjustment objects 360, less a quantity from any previous exemptions. That is, each unit can only be exempted once. An excessive quantity prompts for re-input of the quantity or cancellation of the exemption.

At step 1108, detail for the exemption is received. Detail may be provided by way of a selectable reason for the exemption, such as the levy already being collected (e.g., by a brand inspector), the seller claiming non-producer status (e.g., a short-term owner), or a user-entered reason.

At step 1110, an interface is provided to upload documents to support the exemption. Document upload can be performed as the exemption is being created or at any time before settlement, and it is not strictly necessary to complete step 1110 at the position shown in the flowchart. At any suitable time, the seller can use their terminal 24 to select documents for upload and initiate the upload to the listings system 12. It is contemplated that uploaded documents will be photographs, scans, or electronic versions of documents that support the exemption.

Step 1112 determines whether the exemption meets required criteria. The required criteria can include, for example, the indication of suitable detail for the exemption and the presence of an uploaded document. If the exemption meets required criteria, the exemption is marked as valid.

If the exemption fails to meet the required criteria (such as no supporting document has yet been uploaded), then a warning is issued to the terminal 24 of the seller, at step 1114, and the exemption is marked as requiring correction or supporting document. In one example, the warning is a notification that a supporting document must be uploaded before settlement of the transaction. If such a supporting document is uploaded later before settlement, the exemption is marked as valid. If a supporting document is not uploaded before settlement, the exemption is invalid and not included during settlement.

The process 1100 repeats via step 1116 for as many exemptions as desired for a particular sale. The total exempt quantity for all valid exemptions is determined at step 1118 for use with the process 1000 of FIG. 21.

FIG. 23 shows an example of levy data 1018. In this example, cattle is the product and levies are per head. Not all levy data is shown for sake of brevity. Levy data 1018 includes a plurality of data tables 1200 or other data elements, which are selectable based on selection conditions 1202 and which store relationships between location 1204 and levy 1206. Levy data 1018 further associates payable party identifiers 1210 (e.g., identifiers of organizations or governments) with the levies 1206, so that the appropriate party may be paid. Selection conditions specify 1202 the product origin and destination or other relevant conditions. In the example shown, the table 1200 on the left is associated with selection conditions 1202 that designate it for cattle that originate within Canada and that have a destination within Canada. The table 1200 on the right is associated with selection conditions 1202 that designate it for cattle that originate within Canada and that have a destination within the US. The key for the location field 1204 of the selected table 1200 is the selected location based on the determination made in the process 1000, such as seller address or cattle origin location. Other elements of levy data 1018 can be provided with appropriate selection conditions 1202, such as one or more tables for state and federal levies (e.g., $1.00 per head).

It is advantageous that throughout the pre-sale price negotiation and post-delivery adjustment negotiation, attributes, their values, and input elements for such remain presented in alignment with each other, so as to provide a readily comprehensible history of the purchase and sale of the agricultural product.

Further, in view of the above, it should be apparent that the tight and secure integration of listings and payment systems can advantageously permit these systems to be operated by distinct entities according to their own internal processes, including an agricultural regulatory compliant processes whether required or not, so as to facilitate the handling of a large volume of transactions and provide confidence to buying and selling parties. Further, the capability of structured negotiations, before finalized contract and after delivery of product, beneficially increases efficiency of the process of buying and selling agricultural products, and further allows efficient handling of post-sale adjustments, which may include automatic calculations and arbitration.

Further, in view of the above, it should be apparent that a single settlement account undergoing transactions of a data structure outside the control of the system can be used to quickly process a high volume of payments for buyers and sellers of agricultural products with reduced, minimal, or no error. This can eliminate the need to use multiple settlement accounts and to manually process payments, each of which can delay settlement and result in excessive network communications to process. Further, levy or check-off calculation, collection, and payment is made more efficient.

While the foregoing provides certain non-limiting example embodiments, it should be understood that combinations, subsets, and variations of the foregoing are contemplated. The monopoly sought is defined by the claims.

What is claimed is:

1. A system for processing the exchange of an agricultural product, the system comprising:
at least one listings server including:
a terminal interface configured to receive input data for entering, viewing, and selecting listings objects for the agricultural product, the terminal interface configured to receive the input data via a network from a plurality of buyer terminals and a plurality of seller terminals;
a listings engine configured to process state for each listings object, the listing engine configured to update states of the listings objects based on input from the plurality of buyer terminals and the plurality of seller terminals, each listings object representative of a contract structured from a plurality of predefined attributes of the agricultural product, the state of each listings object configured to range from initial offer, to counteroffer, to binding electronic contract for delivery of the agricultural product;
a listings message interface configured to output listings messages via a network, the listings messages indicative of the states of the listings objects;
at least one payment-settlement server separate from the at least one listings server, the at least one payment-settlement server including:
a payment-settlement message interface connected to the listings message interface via the network, the payment-settlement message interface configured to receive listings messages from the listings message interface, the payment-settlement message interface further configured to send payment-settlement messages to the listings message interface;
an accounts database configured to store payment information associated with the plurality of buyer terminals; and
a payment-settlement engine configured to receive listings messages from the payment-settlement message interface and to create payment-settlement objects and process state of the payment-settlement objects based on the listings messages, each payment-settlement object corresponding to a different listings object and containing at least a subset of data contained in the listings object, the payment-settlement engine further configured to output state of payment-settlement objects to the payment-settlement message interface for creation of payment-settlement messages, the payment-settlement engine further configured to execute transactions based on payment-settlement objects corresponding to listings objects including state defining binding electronic contracts;
wherein the payment-settlement objects are associated with the listings objects via network-based passing of listings messages and payment-settlement messages, and wherein the payment-settlement objects and listings objects are otherwise decoupled from each other.

2. The system of claim 1, wherein the listings message interface includes a listings application program interface (API) and the payment-settlement messages include API calls to the listings API, and further wherein the payment-settlement message interface includes a payment-settlement API and the listings messages include API calls to the payment-settlement API.

3. The system of claim 1, wherein the accounts database is further configured to store payment information associated with the plurality of seller terminals.

4. The system of claim 1, wherein the payment-settlement engine is further configured to associate a plurality of payment-settlement objects to a single listings object.

5. The system of claim 1, wherein the listings engine is further configured to perform a structured negotiation based on input from at least one of a buyer terminal and a seller terminal, such input including values for predefined attributes of a particular listings object that is not yet representative of a binding electronic contract.

6. The system of claim 1, wherein the listings engine is further configured to perform a structured adjustment negotiation based on input from at least a buyer terminal, such input including values for delivered attributes of a particular listings object that is representative of a binding electronic contract.

7. The system of claim 1, further comprising a data feeds engine configured to output data of historic listings objects.

8. The system of claim 1, further comprising a certification engine configured to associate third-party certifications to listings objects.

9. A system for processing the exchange of an agricultural product, the system comprising:
a terminal interface configured to receive input data for entering, viewing, and selecting listings objects for the agricultural product, the terminal interface configured to receive the input data via a network from a plurality of buyer terminals and a plurality of seller terminals;
a listings engine configured to process state for each listings object, the listing engine configured to update states of the listings objects based on input from the plurality of buyer terminals and the plurality of seller terminals, each listings object representative of a contract structured from a plurality of predefined attributes of the agricultural product, the state of each listings object configured to range from initial offer, to counteroffer, to binding electronic contract for delivery of the agricultural product; and
a listings message interface configured to output listings messages via a secure network to a payment-settlement system configured to settle payments for the listings objects, the listings messages indicative of the states of the listings objects.

10. The system of claim 9, wherein the listings engine is further configured to perform a structured negotiation based on input from at least one of a buyer terminal and a seller terminal, such input including values for predefined attributes of a particular listings object that is not yet representative of a binding electronic contract.

11. The system of claim 9, wherein the listings engine is further configured to perform a structured adjustment negotiation based on input from at least a buyer terminal, such input including values for delivered attributes of a particular listings object that is representative of a binding electronic contract.

12. A method of processing an exchange of an agricultural product, the method comprising:
receiving over a network from a first remote terminal data defining a listings object, the listings object representative of a contract structured from a plurality of predefined attributes of the agricultural product, state of the listings object configured to range from initial offer, to counteroffer, to binding electronic contract for delivery of the agricultural product;
receiving over the network from the first remote terminal or a second remote terminal an indication that a current state of the listings object is acceptable;
finalizing a binding electronic contract between parties at the first and second remote terminals based on the accepted current state of the listings object;
receiving over the network from the first or second remote terminal an indication of successful delivery of the agricultural product;
after receiving the indication of the successful delivery, receiving from the first or second remote terminal a delivered attribute of the agricultural product, the delivered attribute of the agricultural product mapping to at least one of the predefined attributes of the agricultural product;
processing an adjustment to the binding electronic contract after receiving the delivered attribute; and
processing a purchase of the agricultural product based on the adjusted binding electronic contract based on the acceptance of the adjustment by the first and second remote terminals.

13. The method of claim 12, further comprising before processing the adjustment, automatically calculating an adjustment amount based on the delivered attribute.

14. The method of claim 12, further comprising, before processing the adjustment, receiving from the first or second remote terminal an indication of the adjustment.

15. The method of claim 14, wherein an adjustment amount is generated by a negotiation process performed between the first and second remote terminals.

16. The method of claim 12, further comprising receiving an adjustment amount via the network from an arbitrator terminal.

17. The method of claim 12, comprising receiving from the first or second remote terminal a plurality of said delivered attributes of the agricultural product, each of the plurality of delivered attributes of the agricultural product mapping to at least one of the predefined attributes of the agricultural product.

18. The method of claim 12, wherein processing the purchase of the agricultural product comprises communicating messages between a listings system and a separate and distinct payment-settlement system.

19. The method of claim 18, wherein the messages are communicated over a secure connection according to a protocol that guarantees delivery.
